(19) United States
(12) Patent Application Publication
(10) Pub. No.: US 2025/0150305 A1
(43) Pub. Date: May 8, 2025

(54) METHOD AND APPARATUS FOR MODULATION IN COMMUNICATION SYSTEM

(71) Applicant: ELECTRONICS AND TELECOMMUNICATIONS RESEARCH INSTITUTE, Daejeon (KR)

(72) Inventors: Gosan NOH, Daejeon (KR); Wooram SHIN, Daejeon (KR); Kyeongpyo KIM, Daejeon (KR); Young Jo KO, Daejeon (KR); Kapseok CHANG, Daejeon (KR)

(73) Assignee: ELECTRONICS AND TELECOMMUNICATIONS RESEARCH INSTITUTE, Daejeon (KR)

(21) Appl. No.: 18/937,638

(22) Filed: Nov. 5, 2024

(30) Foreign Application Priority Data
Nov. 6, 2023 (KR) 10-2023-0151829
Oct. 15, 2024 (KR) 10-2024-0140474

(51) Int. Cl. H04L 25/02; H04L 27/26; H04L 27/36

(52) U.S. Cl. CPC H04L 25/0204; H04L 27/26532; H04L 27/362

(57) ABSTRACT

A method of a second communication node may comprise: obtaining a compensated first reception signal by performing channel estimation between a first communication node and a second communication node for a first transmission signal received from the first communication node; obtaining an offset-demodulated signal and a first demodulated bit sequence by performing offset-demodulation on the first reception signal; obtaining a frequency-domain signal by performing time-to-frequency domain transform on the offset-demodulated signal; obtaining a complex signal sequence by performing subcarrier deallocation on the frequency-domain signal; obtaining a second demodulated bit sequence by performing QAM demodulation on the complex signal sequence according to the first demodulated bit sequence; and obtaining a final demodulated bit sequence by performing reassembly on the first demodulated bit sequence and the second demodulated bit sequence.

### CROSS-REFERENCE TO RELATED APPLICATIONS

This application claims priority to Korean Patent Applications No. 10-2023-0151829, filed on Nov. 6, 2023, and No. 10-2024-0140474, filed on Oct. 15, 2024, with the Korean Intellectual Property Office (KIPO), the entire contents of which are hereby incorporated by reference.

### BACKGROUND

### 1. Technical Field

The present disclosure relates to a waveform and a modulation technique in a communication system, and more particularly, to a modulation technique utilizing an amplitude and phase offset.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Recently, researches on broadband transmission that utilize a wide bandwidth for high-speed data transmission in communication systems have been actively conducted. To leverage wide bandwidth, the effects of frequency synchronization error, phase noise, and Doppler spread should be considered. In ultra-high frequency bands, such as millimeter wave (mmWave) or sub-terahertz (sub-THz) bands, severe signal distortion may occur due to these factors. This distortion may cause critical performance degradation in multi-carrier systems such as orthogonal frequency division multiplexing (OFDM) systems. Therefore, technologies to mitigate signal distortion in ultra-high frequency bands are be required.

### SUMMARY

The present disclosure for resolving the above-described problems is directed to providing a modulation method and apparatus utilizing an amplitude and phase offset in a communication system.

A method of a second communication node, according to exemplary embodiments of the present disclosure for achieving the above-described objective, may comprise: obtaining a compensated first reception signal by performing channel estimation between a first communication node and a second communication node for a first transmission signal received from the first communication node; obtaining an offset-demodulated signal and a first demodulated bit sequence by performing offset-demodulation on the first reception signal according to offset-modulation information; obtaining a frequency-domain signal by performing time-to-frequency domain transform on the offset-demodulated signal according to the offset-modulation information or subcarrier allocation information; obtaining a complex signal sequence by performing subcarrier deallocation on the frequency-domain signal according to the subcarrier allocation information; obtaining a second demodulated bit sequence by performing quadrature amplitude modulation (QAM) demodulation on the complex signal sequence according to QAM modulation information and the first demodulated bit sequence; and obtaining a final demodulated bit sequence by performing reassembly on the first demodulated bit sequence and the second demodulated bit sequence.

The offset-demodulated signal may be obtained after obtaining the first demodulated bit sequence, and the frequency-domain signal may be obtained by applying one of a discrete Fourier transform (DFT), a discrete cosine transform (DCT), or a discrete sine transform (DST).

The method may further comprise: receiving modulation configuration information from the first communication node, wherein the modulation configuration information may be received through at least one of physical layer signaling, medium access control (MAC) layer signaling, radio resource control (RRC) signaling, or system information (SI) signaling.

The modulation configuration information may include at least one of the offset modulation information, the subcarrier allocation information, or the QAM modulation information.

The offset modulation information may include at least one of information indicating application of amplitude-based offset modulation or amplitude offset modulation step information, the amplitude offset modulation step information may include information indicating two or more amplitude modulation steps or information on at least one amplitude threshold related to the two or more amplitude modulation steps, the first demodulated bit sequence may be obtained by using at least one of an amplitude of the first reception signal or the at least one amplitude threshold, and the offset-demodulated signal may be obtained by using at least one of the first reception signal or the first demodulated bit sequence.

The offset-demodulated signal may be one of a signal normalized so that the amplitude of the first reception signal becomes 1, a signal in which an amplitude offset of the first reception signal is canceled out, or the first reception signal.

The offset modulation information may include at least one of information indicating application of phase-based offset modulation or phase offset modulation step information, the phase offset modulation step information may include information indicating two or more phase modulation steps or information on at least one phase threshold related to the two or more phase modulation steps, the first demodulated bit sequence may be obtained by using at least one of a phase of the first reception signal or the at least one phase threshold, and the offset-demodulated signal may be obtained by using at least one of the first reception signal or the first demodulated bit sequence.

The subcarrier allocation information may include information indicating application of a first subcarrier allocation scheme, the complex signal sequence may be obtained by using at least one of a first region or a second region including the frequency-domain signal, and a QAM-modulated signal to which subcarriers are allocated by the first communication node, which corresponds to the frequency-domain signal included in the first region and the second region, may be conjugate symmetric in frequency domain.

The subcarrier allocation information may include information indicating application of a second subcarrier allocation scheme, the complex signal sequence may be obtained by using the frequency-domain signal, the frequency-domain signal may be a complex signal including a first region corresponding to real components and a second region corresponding to imaginary components, the first region and the second region may be continuous in frequency domain, and the second region may be located after the first region.

The obtaining of the complex signal sequence may comprise: obtaining an instantaneous phase signal by performing phase demodulation on the offset-demodulated signal according to the offset modulation information; obtaining an instantaneous frequency signal by performing frequency demodulation on the instantaneous phase signal according to the subcarrier allocation information; obtaining the frequency-domain signal by performing time-to-frequency domain transform on the instantaneous frequency signal according to the subcarrier allocation information; and obtaining the complex signal sequence from the frequency-domain signal by performing subcarrier deallocation on the frequency-domain signal according to the subcarrier allocation information.

A method of a first communication node, according to exemplary embodiments of the present disclosure for achieving the above-described objective, may comprise: separating information bits to be transmitted to a second communication node into a first bit sequence and a second bit sequence; obtaining a quadrature amplitude modulation (QAM)-modulated signal by performing QAM modulation on the first bit sequence according to QAM modulation information; obtaining a frequency-domain signal by performing subcarrier allocation on the QAM-modulated signal according to subcarrier allocation information; obtaining a time-domain signal by performing frequency-to-time domain transform on the frequency-domain signal; obtaining an offset-modulated signal by performing offset-modulation on the time-domain signal according to offset-modulation information and the second bit sequence; and transmitting a first transmission signal generated using the offset-modulated signal to the second communication node, wherein the frequency-domain signal is transformed into the time-domain signal by applying one of an inverse discrete Fourier transform (IDFT), an inverse discrete cosine transform (IDCT), or an inverse discrete sine transform (IDST).

The method may further comprise: transmitting modulation configuration information to the second communication node, wherein the modulation configuration information may be transmitted through at least one of physical layer signaling, medium access control (MAC) layer signaling, radio resource control (RRC) signaling, or system information (SI) signaling.

The modulation configuration information may include at least one of the offset modulation information, the subcarrier allocation information, or the QAM modulation information.

The subcarrier allocation information may include information indicating application of a first subcarrier allocation scheme, the frequency-domain signal may include a first region and a second region to which the QAM-modulated signal is allocated within an entire subcarrier region, the first region and the second region may be conjugate symmetrical with respect to a center of the entire subcarrier region, a central region between the first region and the second region may be a portion to which the QAM-modulated signal is not allocated, and the frequency-domain signal may be transformed into the time-domain signal through IDFT.

The subcarrier allocation information may include information indicating application of a second subcarrier allocation scheme, the frequency-domain signal may include a first region and a second region which are continuous, the second region may be located after the first region, the first region may correspond to real components of the QAM-modulated signal, the second region may correspond to values obtained by converting imaginary components of the QAM-modulated signal to ream numbers, and the frequency-domain signal may be transformed into the time-domain signal through one of IDCT or IDST.

When the frequency-domain signal is determined to be located in a subcarrier region higher than a predefined subcarrier in the entire subcarrier region, the frequency-domain signal may be transformed into the time-domain signal by applying IDST, and when the frequency-domain signal is determined to be located in a subcarrier region lower than the predefined subcarrier in the entire subcarrier region, the frequency-domain signal may be transformed into the time-domain signal by applying one of IDFT or IDCT.

The offset modulation information may include at least one of information indicating application of amplitude-based offset modulation or amplitude offset modulation step information, and the offset-modulated signal may be an amplitude-based offset-modulated signal, an amplitude of the offset-modulated signal may be determined according to the second bit sequence, and the amplitude offset modulation step information may be information indicating two or more modulation steps.

The obtaining of the offset-modulated signal may comprise: obtaining an instantaneous phase signal by performing frequency demodulation on the time-domain signal; obtaining a phase-modulated signal by performing phase modulation on the instantaneous phase signal; and obtaining the offset-modulated signal by performing the offset modulation on the phase-modulated signal according to at least one of the offset modulation information or the second bit sequence.

A second communication node, according to exemplary embodiments of the present disclosure for achieving the above-described objective, may comprise at least one processor, wherein the at least one processor causes the second communication node to perform: obtaining a compensated first reception signal by performing channel estimation between a first communication node and a second communication node for a first transmission signal received from the first communication node; obtaining an offset-demodulated signal and a first demodulated bit sequence by performing offset-demodulation on the first reception signal according to offset-modulation information; obtaining a frequency-domain signal by performing time-to-frequency domain transform on the offset-demodulated signal according to the offset-modulation information or subcarrier allocation information; obtaining a complex signal sequence by performing subcarrier deallocation on the frequency-domain signal according to the subcarrier allocation information; obtaining a second demodulated bit sequence by performing quadrature amplitude modulation (QAM) demodulation on the complex signal sequence according to QAM modulation information and the first demodulated bit sequence; and obtaining a final demodulated bit sequence by performing reassembly on the first demodulated bit sequence and the second demodulated bit sequence.

The offset-demodulated signal may be obtained after obtaining the first demodulated bit sequence, and the frequency-domain signal may be obtained by applying one of a discrete Fourier transform (DFT), a discrete cosine transform (DCT), or a discrete sine transform (DST).

According to the present disclosure, signal distortion caused by the effects of frequency synchronization error, phase noise, and Doppler spread in ultra-high frequency bands such as millimeter wave (mmWave) or sub-terahertz (sub-THz) bands can be mitigated. A modulation method based on amplitude and phase offset can improve data transmission rates, frequency efficiency, and link performance in communication systems. To enhance link performance in communication systems, spreading techniques in the frequency domain can be applied. When the modulation method based on amplitude and phase offset is utilized in communication systems, the overall system performance can be improved.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a block diagram illustrating an amplitude and phase offset-based modulation method according to exemplary embodiments of the present disclosure.

FIG. 4 is a conceptual diagram illustrating a first subcarrier allocation scheme according to exemplary embodiments of the present disclosure.

FIG. 5 is a conceptual diagram illustrating a second subcarrier allocation scheme according to exemplary embodiments of the present disclosure.

FIG. 6 is a conceptual diagram illustrating a first offset modulation scheme according to exemplary embodiments of the present disclosure.

FIG. 7 is a conceptual diagram illustrating a second offset modulation scheme according to exemplary embodiments of the present disclosure.

FIG. 8 is a conceptual diagram illustrating a first subcarrier deallocation scheme according to exemplary embodiments of the present disclosure.

FIG. 9 is a conceptual diagram illustrating a second subcarrier deallocation scheme according to exemplary embodiments of the present disclosure.

FIG. 10 is a block diagram illustrating an additional modulation method based on amplitude and phase offset according to exemplary embodiments of the present disclosure.

FIG. 11 is a block diagram illustrating a frequency domain spreading process included in the amplitude and phase offset-based additional modulation method according to exemplary embodiments of the present disclosure.

FIG. 12 is a block diagram illustrating a frequency domain despreading process included in the amplitude and phase offset-based additional modulation method according to exemplary embodiments of the present disclosure.

FIG. 13 is a sequence chart illustrating a transmission and reception procedure of an amplitude and phase offset-based modulated signal according to exemplary embodiments of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

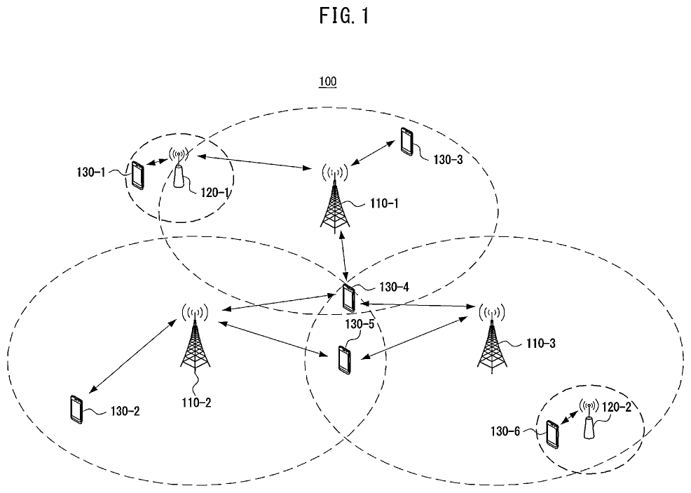

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G communication may be performed in frequency bands above 6 GHz as well as frequency bands below 6 GHz. The 6G communication may enable data transmission at 1 Tbps in a terahertz band and integrate terrestrial and non-terrestrial communications.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

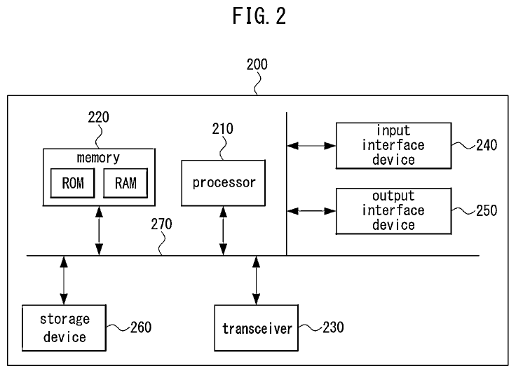

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like. Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

### <Modulation Methods in Communication Systems>

In communication systems, waveforms based on multi-carrier schemes may be utilized for high-speed data transmission. For high-speed data transmission, broadband transmission using a wide bandwidth may be required. However, signal degradation and distortion may occur due to frequency-selective fading caused by a time delay in wireless channels. The effects of such frequency-selective fading can be mitigated by dividing the entire bandwidth into multiple carrier sections with narrow frequency intervals and transmitting the multiple carrier sections. Although the entire band is frequency-selective, the divided carrier section can be approximated as experiencing frequency-nonselective fading, and signal degradation and distortion can be mitigated through equalization at a receiver.

A representative example of a scheme using such multi-carrier transmission is orthogonal frequency division multiplexing (OFDM). In the case of OFDM, modulation and demodulation can be performed using fast Fourier transform (FFT), enabling construction of multi-carrier waveforms with low complexity. Additionally, channel compensation can be achieved with a single-tap equalizer in the frequency domain. In a cyclic prefix (CP)-OFDM scheme, a cyclic prefix (CP) can be applied to mitigate effects of channel delay spreading. In the frequency domain, techniques such as interleaving can facilitate acquisition of frequency diversity. Furthermore, frequency resources can be divided on a subcarrier basis, making the implementation of multiple access more straightforward. Thanks to these advantages, the CP-OFDM waveform has been adopted as a primary waveform in systems such as 4G LTE and 5G NR systems.

In the CP-OFDM, orthogonality between subcarriers should be maintained. However, factors such as timing synchronization errors, frequency synchronization errors, phase noises, and Doppler spread may disrupt the orthogonality between subcarriers. When the orthogonality between subcarriers is broken, inter-carrier interference (ICI) may occur, resulting in signal distortion. The impact of frequency synchronization errors, phase noises, and Doppler spread may become more severe in extremely high-frequency bands such as millimeter-wave (mmWave) or sub-terahertz (sub-THz) bands. The phase noises may exhibit quadratic growth with respect to frequency, and the maximum Doppler shift may increase in proportion to the frequency.

The OFDM waveform has a potential drawback of exhibiting a very high peak-to-average power ratio (PAPR). The high PAPR may impose significant limitations on aspects such as a modulation order. To ensure that a signal waveform remains within a dynamic range of an amplifier, a signal power should be backed off, which may degrade both coverage and signal quality. This issue may be particularly critical in mmWave or sub-THz bands, where outputs of a power amplifier (PA) may be saturated prematurely. Furthermore, the saturated output power may tend to decrease as the frequency increases.

To overcome the aforementioned drawbacks of CP-OFDM, various waveform design techniques have been be proposed. For example, an orthogonal time frequency space (OTFS) modulation has been introduced as a waveform robust against Doppler spread. The OTFS modulation transforms data into a delay domain and a Doppler domain, making it resilient to time and frequency variations. As another example, filter bank multi-carrier (FBMC) modulation, which applies filtering in the frequency domain, has been proposed as a waveform to address issues caused by frequency offset.

To minimize the impact of PAPR, discrete Fourier transform (DFT)-spread-OFDM (DFT-s-OFDM) may be used. The DFT-s-OFDM is also known as single carrier-OFDM (SC-OFDM), and it reduces PAPR in the time domain by applying DFT spreading operations to signals allocated to a certain frequency region in CP-OFDM. Accordingly, a power back-off of a transmitted signal can be reduced, power efficiency can be improved, and coverage can be enhanced. Due to these characteristics, the DFT-s-OFDM has been employed as an uplink waveform in the 4G LTE and 5G NR systems.

Amplitude phase shift keying (APSK) may be one of the techniques being explored in waveform research to reduce PAPR. Transmission symbols can be arranged in a circular constellation, which helps lower the PAPR.

Index modulation (IM) may be another waveform that can be resilient to RF impairments. The IM may use a scheme of using indices that differentiate wireless resources such as space, frequency, time, or polarization. Since it does not rely on modulation based on power differences, it offers the advantage of avoiding power efficiency degradation caused by RF impairments, especially in sub-THz bands.

Through the development of technologies for PAPR minimization, constant envelope (CE)-OFDM with a 0 dB PAPR has been proposed. A CE-OFDM signal, based on amplitude modulation, can be generated by performing phase modulation in form of a complex exponential function. The key advantage of the CE-OFDM waveform is that it can completely resolve the PAPR issue. However, the disadvantage of the CE-OFDM waveform is that, since modulation relies solely on phase information, it is highly susceptible to phase noises and Doppler spreads. On the other hand, a frequency modulated (FM)-OFDM offers the same 0 dB PAPR characteristics while being more robust against phase noises and Doppler spreads. In the case of FM-OFDM, an CP-OFDM signal, which was traditionally transmitted using amplitude modulation, may be transmitted using frequency modulation. As a result, performance degradation in high Doppler environments is less severe compared to the CP-OFDM and CE-OFDM.

Both CE-OFDM and FM-OFDM may require conjugate symmetric operations in the frequency domain to perform phase modulation with real-valued signals. As a result, twice the frequency resources may be used compared to CP-OFDM, leading to reduction in frequency efficiency by half. In addition, CE-OFDM and FM-OFDM may occupy wider frequency bandwidths in proportion to a modulation index. Consequently, their frequency efficiency may be lower than that of CP-OFDM.

### <<Amplitude and Phase Offset-Based Modulation Methods>>

An amplitude and phase offset-based modulation method described in the present disclosure may be applied to downlink (DL), uplink (UL), and/or sidelink (SL) in communication systems. Operations of the amplitude and phase offset-based modulation method according to the present disclosure may be illustrated through the following block diagram.

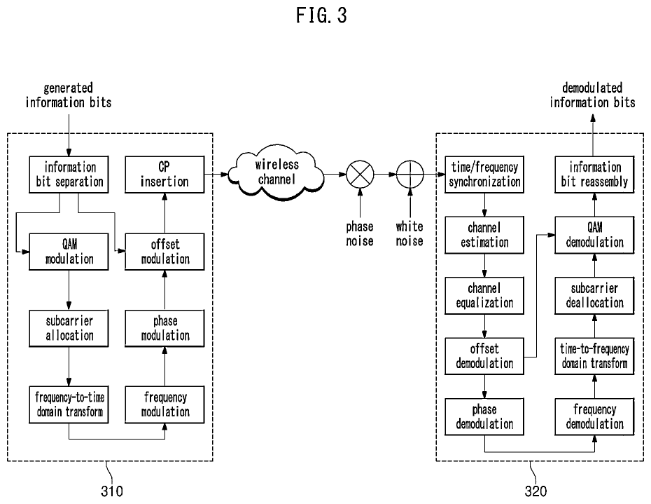

FIG. 3 is a block diagram illustrating an amplitude and phase offset-based modulation method according to exemplary embodiments of the present disclosure.

Referring to FIG. 3, a communication system may include a first communication node and a second communication node. The first communication node may include a transmission unit (hereinafter, ‘amplitude and phase offset-based transmission unit’) 310 to which the amplitude and phase offset-based modulation method is applied. The second communication node may include a reception unit (hereinafter, ‘amplitude and phase offset-based reception unit’) 320 for a reception signal to which the amplitude and phase offset-based modulation method is applied. The first communication node may obtain a modulated transmission signal by applying the amplitude and phase offset-based transmission unit 310 to generated information bits. The first communication node may transmit the modulated transmission signal to the second communication node, and the second communication node may receive the modulated transmission signal from the first communication node. Phase noise and white noise may be added to the modulated transmission signal received by the second communication node while passing through a wireless channel.

Referring again to FIG. 3, the second communication node may obtain (or generate) restored information bits by applying the amplitude and phase offset-based reception unit 320 to the received modulated transmission signal. In the amplitude and phase offset-based transmission unit 310, the generated information bits may be separated into a first bit sequence and a second bit sequence. The first bit sequence may be used for QAM modulation, and the second bit sequence may be used for offset modulation. In the amplitude and phase offset-based reception unit 320, the second bit sequence may be restored through offset demodulation, and the first bit sequence may be restored through QAM demodulation. The amplitude and phase offset-based reception unit 320 may obtain restored information bits by reassembling the restored first bit sequence and the restored second bit sequence. The operation of the amplitude and phase offset-based transmission unit 310 and the operation of the amplitude and phase offset-based reception unit 320 will be described later.

In FIG. 3, the first communication node may be one of a base station or a terminal, and the second communication node may be one of the terminal or the base station. If the first communication node is a base station, the second communication node may be a terminal, and the transmission signal may be a downlink (DL) signal. If the first communication node is a terminal, the second communication node may be a base station, and the transmission signal may be an uplink (UL) signal. The first communication node and the second communication node may be terminals, and the transmission signal may be a sidelink (SL) signal. The base station may be the base station 110-1, 110-2, 110-3, 120-1, or 120-2 illustrated in FIG. 1, and the terminal may be the terminal 130-1, 130-2, 130-3, 130-4, 130-5, or 130-6 illustrated in FIG. 1. The base station and the terminal may be configured identically or similarly to the communication node illustrated in FIG. 2.

In FIG. 3, the amplitude and phase offset-based transmission unit 310 and the phase offset-based reception unit 320 may each be software or hardware components.

### <First Communication Node: Transmission Method of Amplitude and Phase Offset-Based Modulated Signal>

When the amplitude and phase offset-based modulation method proposed in the present disclosure is applied to the first communication node, as illustrated in FIG. 3, the first communication node may include the amplitude and phase offset-based transmission unit 310. In the first communication node, the amplitude and phase offset-based transmission unit 310 may perform the following operations.

### [Process Tx-1] Information Bit Separation

In the process Tx-1, an operation of separating the generated information bits may be performed. The generated information bits may be expressed as an information bit sequence bᵢ. The first communication node may separate the information bit sequence bᵢ into a bit sequence bᵢ_{₁} composed of N_{b}⁽¹⁾ bits to be applied to QAM modulation and a bit sequence bᵢ_{₂} composed of N_{b}⁽²⁾ bits to be applied to offset modulation. The first communication node may perform a process Tx-2 to perform QAM modulation on the bit sequence bᵢ_{₁} composed of N_{b}⁽¹⁾ bits.

As illustrated in FIG. 3, the amplitude and phase offset-based transmission unit 310 may include an information bit separator block. In the first communication node, the process Tx-1 may be performed in the information bit separator block included in the amplitude and phase offset-based transmission unit 310. The information bit separator block may be referred to as an information bit separator.

### [Process Tx-2] QAM Modulation

In the process Tx-2, the first communication node may perform QAM modulation on the bit sequence bᵢ_{₁} composed of N_{b}⁽¹⁾ bits separated in the process Tx-1. When QAM modulation is performed, the bit sequence bᵢ_{₁} may be converted into a signal having a complex number form. The first communication node may perform QAM modulation on the bit sequence bᵢ_{₁} to obtain a QAM modulated signal.

When QAM modulation is performed, the first communication node may generate quadrature phase shift keying (QPSK), 16 QAM, 64 QAM, 256 QAM, or 1024 QAM signals depending on a modulation order. The bit sequence bᵢ_{₁} separated in the process Tx-1 may be converted into a QAM-modulated signal composed of Nₛ=N_{b}⁽¹⁾/log₂ M QAM modulated symbols in the process Tx-2. The QAM-modulated signal may be represented as Xⱼ. M (a positive integer ≥2) may represent the modulation order, and M may be a power of 2.

As illustrated in FIG. 3, the amplitude and phase offset-based transmission unit 310 may include a QAM modulation block. In the first communication node, the process Tx-2 may be performed in the QAM modulation block included in the amplitude and phase offset-based transmission unit 310. The QAM modulation block may be referred to as a QAM modulator.

### [Process Tx-3] Subcarrier Allocation

In the process TX-3, the first communication node may perform subcarrier allocation on the QAM-modulated signal obtained in the process Tx-2. In the first communication node, if the subcarrier allocation is successfully performed, the first communication node may obtain a frequency-domain signal for the QAM-modulated signal. In order to obtain the frequency-domain signal, the first communication node may apply (or perform) a first subcarrier allocation scheme or a second subcarrier allocation scheme for the QAM-modulated signal.

As illustrated in FIG. 3, the amplitude and phase offset-based transmission unit 310 may include a subcarrier allocation block. In the first communication node, the process Tx-3 may be performed in the subcarrier allocation block included in the amplitude and phase offset-based transmission unit 310. The subcarrier allocation block may be referred to as a subcarrier allocator.

### First Subcarrier Allocation Scheme

When the first subcarrier allocation scheme is applied to (or performed in) the amplitude and phase offset-based transmission unit 310, subcarriers may have the following conjugate symmetry structure.

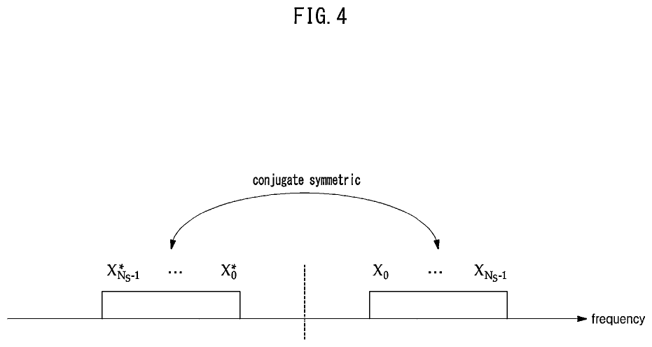

FIG. 4 is a conceptual diagram illustrating a first subcarrier allocation scheme according to exemplary embodiments of the present disclosure.

Referring to FIG. 4, in the first subcarrier allocation scheme, the QAM-modulated signal may not be allocated to the entire subcarrier region. The QAM-modulated signal to which subcarriers are allocated may have conjugate symmetry in the frequency domain. Based on a center of the entire subcarrier region, a first region and a second region may have complex conjugate values and may have a symmetrical form. The first region may represent a half of a region where subcarriers are allocated to the QAM-modulated signal, and the second region may represent a remaining half of the region where subcarriers are allocated to the QAM-modulated signal. In FIG. 4, X*ᵢ(i=0, . . . , Nₛ−1) may represent complex conjugates of Xᵢ(i=0, . . . , Nₛ−1). In FIG. 4, for convenience of description, a central region between the first region and the second region is illustrated as being zero-padded, but the present disclosure is not limited thereto.

In an exemplary embodiment, a subcarrier region (e.g. the central region between the first region and the second region) where the QAM-modulated signal is not allocated within the entire subcarrier region may be zero-padded.

In another exemplary embodiment, the first region and the second region may each occupy half of the entire subcarrier region. There may not be a subcarrier region (e.g. the central region between the first region and the second region) where the QAM-modulated signal is not allocated within the entire subcarrier region. In other words, when the first region and the second region each occupy half of the entire subcarrier region based on the center of the entire subcarrier region, the first region and the second region may have complex conjugate values and may be symmetrical.

### Second Subcarrier Allocation Scheme

When the second subcarrier allocation scheme is applied to (or performed in) the amplitude and phase offset-based transmission unit 310, subcarriers may have the following continuous structure.

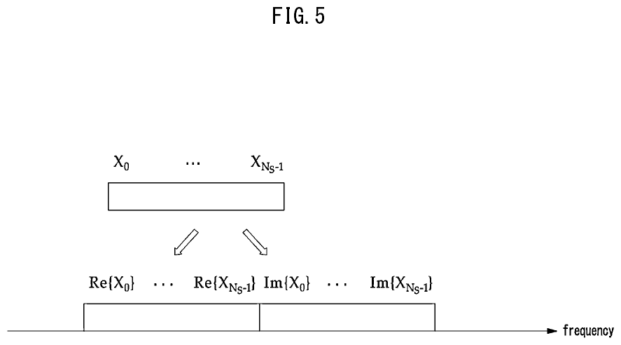

FIG. 5 is a conceptual diagram illustrating a second subcarrier allocation scheme according to exemplary embodiments of the present disclosure.

Referring to FIG. 5, the second subcarrier allocation scheme allocate subcarriers to the QAM-modulated signal by dividing the entire subcarrier region into a first region and a second region that are continuous in the frequency domain. The first region may be a region where subcarriers are allocated for real parts of the QAM-modulated signal, and the second region may be a region where subcarriers are allocated for imaginary parts of the QAM-modulated signal.

In FIG. 5, the second subcarrier allocation scheme may divide the QAM-modulated signal into the real parts and the imaginary parts. The imaginary parts of the QAM-modulated signal may be converted into a real form by separating a sign and a value of each imaginary part. The second subcarrier allocation scheme may use only real parts for the QAM-modulated signal. In other words, the complex QAM-modulated signal comprising Nₛ complex symbols may be converted into a signal comprising 2Nₛ real symbols. The converted 2Nₛ real symbols may be allocated to occupy a certain portion of the entire subcarrier region.

Then, a method of transforming the frequency-domain signal into a time-domain signal will be described.

### [Process Tx-4] Time Domain Transform

In the process Tx-4, the first communication node may perform transform of the frequency-domain signal obtained in the process Tx-3 into a time-domain signal. In order to transform the frequency-domain signal into the time-domain signal, the first communication node may apply (or perform) a first frequency-to-time domain transform scheme or a second frequency-to-time domain transform scheme.

When the first subcarrier allocation scheme is applied (or performed), the first communication node may apply (or perform) the first frequency-to-time domain transform scheme as a scheme for transforming the frequency-domain signal into the time domain signal. When the second subcarrier allocation scheme is applied (or performed), the first communication node may apply (or perform) the second frequency-to-time domain transform scheme as a scheme for transforming the frequency-domain signal into the time-domain signal.

In the first frequency-to-time domain transform scheme, the first communication node may perform an inverse discrete Fourier transform (IDFT). In the second frequency-to-time domain transform scheme, the first communication node may perform one of an inverse discrete cosine transform (IDCT) or an inverse discrete sine transform (IDST).

When the first communication node transforms the frequency-domain signal into the time-domain signal, the first communication node may perform transform of the frequency-domain signal into the time-domain signal by considering position(s) of the frequency-domain signal allocated in the frequency domain.

In an exemplary embodiment, it may be assumed that the frequency-domain signal of the first communication node is located in a subcarrier region lower than a predefined subcarrier in the entire subcarrier region (or the entire frequency region).

The first communication node may perform a comparison between the region where the frequency-domain signal is located and the predefined subcarrier. If it is determined that the frequency-domain signal is located in a subcarrier region lower than the predefined subcarrier within the entire subcarrier region (or the entire frequency region), the first communication node may select one of IDFT or IDCT to transform the frequency-domain signal into the time-domain signal. The first communication node may perform the selected transform to transform the frequency-domain signal into the time-domain signal.

In another exemplary embodiment, it may be assumed that the frequency-domain signal of the first communication node is located in a subcarrier region higher than the predefined subcarrier within the entire subcarrier region (or the entire frequency region).

The first communication node may perform a comparison between the region where the frequency-domain signal is located and the predefined subcarrier. If it is determined that the frequency-domain signal is located in a subcarrier region higher than the predefined subcarrier within the entire subcarrier region (or the entire frequency region), the first communication node may perform IDST to transform the frequency-domain signal into the time-domain signal.

As illustrated in FIG. 3, the amplitude and phase offset-based transmission unit 310 may include a frequency-to-time domain transform block. In the first communication node, the process Tx-4 may be performed in the frequency-to-time domain transform block included in the amplitude and phase offset-based transmission unit 310. The frequency-to-time domain transform block may be referred to as a frequency-to-time domain transform.

### First Frequency-to-Time Domain Transform Scheme

When the first frequency-to-time domain transform scheme is applied (or performed) to the first communication node, the first communication node may select IDFT to transform the frequency-domain signal into the time-domain signal. The first communication node may perform the selected IDFT on the frequency-domain signal to transform the frequency-domain signal into the time-domain signal. IDFT may be expressed as in Equation 1. The frequency-domain signal may be obtained by applying (or performing) the first subcarrier allocation scheme.

$${f}_{1} [ n ] = m \frac{1}{\sqrt{{N}_{a}}} {\sum }_{k = 0}^{N - I} X [ k ] {e}^{\frac{j 2 π kn}{N}} \qquad [ Equation l ]$$

In Equation 1, f₁[n] may represent the time-domain signal obtained by performing IDFT, and X[k] may represent the frequency-domain signal. N may represent the size of IDFT, and N_{α} may represent the number of subcarriers. m may represent a modulation index, and m may be used to adjust an amplitude of the signal transformed into the time domain.

In the first frequency-to-time domain transform scheme, the IDFT may be replaced with an inverse fast Fourier transform (IFFT). The size N of IFFT may be a power of 2.

### Second Frequency-to-Time Domain Transform Scheme

When the second frequency-to-time domain transform scheme is applied (or performed) to the first communication node, the first communication node may select one of IDCT or IDST to transform the frequency-domain signal into the time-domain signal. The first communication node may perform the selected one of the transforms to transform the frequency-domain signal into the time-domain signal. IDCT may be expressed as in Equation 2, and IDST may be expressed as in Equation 3.

$${f}_{2} [ n ] = m \frac{1}{\sqrt{{N}_{a}}} {\sum }_{k = 0}^{N - 1} X [ k ] {β}_{k} cos ( \frac{π k ( 2 n + 1 )}{2 N} ) \qquad [ Equation 2 ]$$

In Equation 2, f₂[n] may represent the time-domain signal obtained by performing IDCT. When k=0, β₀=1/\sqrt{2}, and when k≠0, βₖ−1.

$${f}_{3} [ n ] = m \frac{1}{\sqrt{{N}_{a}}} \frac{N}{N + 1} {\sum }_{k = 0}^{N - 1} X [ k ] sin ( \frac{π ( n + 1 ) ( k + 1 )}{N + 1} ) \qquad [ Equation 3 ]$$

In Equation 3, f₃[n] may represent the time-domain signal obtained by performing IDST.

As described above, when the first communication node applies (or performs) the second subcarrier allocation scheme in the process Tx-3, the first communication node may apply (or perform) the second frequency-to-time domain transform scheme in the process Tx-4. When the second subcarrier allocation scheme is applied in the process Tx-3, the frequency-domain signal may be expressed as illustrated in FIG. 5.

When the first communication node performs IDCT or IDST on the frequency-domain signal, the first communication node may perform the transform to a form having only real components in both the frequency domain and the time domain.

### [Process Tx-5] Frequency Modulation

In the process Tx-5, the first communication node may perform frequency modulation on the time-domain signal obtained in the process Tx-4. When the first communication node performs frequency modulation, the first communication node may obtain an instantaneous phase signal for the time-domain signal. In order to obtain the instantaneous phase signal, the first communication node may apply (or perform) a first frequency modulation scheme or a second frequency modulation scheme.

As illustrated in FIG. 3, the amplitude and phase offset-based transmission unit 310 may include a frequency modulation block. In the first communication node, the process Tx-5 may be performed in the frequency modulation block included in the amplitude and phase offset-based transmission unit 310. The frequency modulation block may be referred to as a frequency modulator.

### First Frequency Modulation Scheme

When the first frequency modulation scheme is applied (or performed) to the first communication node, the time-domain signal may be obtained through Equation 1, Equation 2, or Equation 3 described above. The first communication node may obtain an instantaneous phase signal by calculating a cumulative sum for the time-domain signal. The instantaneous phase signal may be expressed as in Equation 4.

$${φ}_{t} [ n ] = {φ}_{0} + 2 π {\sum }_{{n}^{′} = 0}^{n} {f}_{l} [ {n}^{′} ] \qquad [ Equation 4 ]$$

In Equation 4, φₜ[n] may represent the instantaneous phase signal. φ₀ may be 0 or a value where an average value of φₜ[n] becomes 0. l may be defined as l∈{1, 2, 3}.

f₁[n] may represent the time-domain signal obtained by performing IDFT as shown in Equation 1. f₂[n] may represent the time-domain signal obtained by performing IDCT as shown in Equation 2. f₃[n] may represent the time-domain signal obtained by performing IDST as shown in Equation 3.

When the average value of φₜ[n] is 0, the instantaneous phase signal φₜ[n] may exceed a range of [−π, π). If the second communication node performs phase demodulation, the phase ambiguity phenomenon may be minimized.

### Second Frequency Modulation Scheme

When the second frequency modulation scheme is applied (or performed) to the first communication node, the first communication node may not perform frequency modulation on the time-domain signal. The first communication node may obtain an instantaneous phase signal for the time-domain signal. The instantaneous phase signal may be expressed as in Equation 5.

$${φ}_{t} [ n ] = 2 π {f}_{l} [ n ] \qquad [ Equation 5 ]$$

In Equation 5, φₜ[n] may represent the instantaneous phase signal. 1 may be defined as l∈{1, 2, 3}.

Hereinafter, a phase modulation method for the instantaneous phase signal will be described.

### [Process Tx-6] Phase Modulation

In the process Tx-6, the first communication node may perform phase modulation on the instantaneous phase signal obtained in the process Tx-5. When the first communication node performs phase modulation, the first communication node may obtain a phase-modulated signal for the instantaneous phase signal. The phase-modulated signal may be expressed as in Equation 6.

$$\overline{s} [ n ] = A exp ( j {φ}_{t} [ n ] ) \qquad [ Equation 6 ]$$

In Equation 6. s̅[n] may represent the phase-modulated signal, and A may be a constant for the amplitude size. φₜ[n] may represent the instantaneous phase signal.

When the first communication node performs phase modulation on the instantaneous phase signal, the first communication node may obtain a phase-modulated signal having a constant envelope.

As illustrated in FIG. 3, the amplitude and phase offset-based transmission unit 310 may include a phase modulation block. In the first communication node, the process Tx-6 may be performed in the phase modulation block included in the amplitude and phase offset-based transmission unit 310. The phase modulation block may be referred to as a phase modulator.

### [Process Tx-7] Offset Modulation

In the process Tx-7, the first communication node may perform offset modulation on the phase-modulated signal obtained in the process Tx-6. When the first communication node performs offset modulation, the first communication node may obtain an offset-modulated signal for the phase-modulated signal using the bit sequence separated in the process Tx-1. To obtain the offset-modulated signal, the first communication node may apply (or perform) a first offset modulation scheme or a second offset modulation scheme.

As described above, in the process Tx-1, the information bit sequence bᵢ may be separated into the bit sequence bᵢ_{₁} composed of N_{b}⁽¹⁾ bits to be applied to QAM modulation and the bit sequence bᵢ_{₂} composed of N_{b}⁽²⁾ bits to be applied to offset modulation. N_{b}⁽²⁾ may be equal to or less than a computational unit N in performing IDFT, IDCT or IDST.

The first offset modulation scheme may be an amplitude-based offset modulation scheme. The second offset modulation scheme may be a phase-based offset modulation scheme.

As illustrated in FIG. 3, the amplitude and phase offset-based transmission unit 310 may include an offset modulation block. In the first communication node, the process Tx-7 may be performed in the offset modulation block included in the amplitude and phase offset-based transmission unit 310. The offset modulation block may be referred to as an offset modulator.

### First Offset Modulation Scheme

When the first offset modulation scheme is applied (or performed) to the first communication node, the first communication node may perform modulation so that a difference value of the amplitude for the phase-modulated signal is used as a means of information transfer (or transmission). The phase-modulated signal may refer to the signal obtained by performing the above-described process Tx-6. The phase-modulated signal s̅[n] may have a constant amplitude A as shown in Equation 6. The difference value of the amplitude may refer to an offset of the amplitude.

In an exemplary embodiment, when a bit of the bit sequence bᵢ_{₂} to be applied to offset modulation is ‘0’, the amplitude of the offset-modulated signal may be determined (or set) as A₀. When a bit of the bit sequence bᵢ_{₂} to be applied to offset modulation is ‘1’, the amplitude of the offset-modulated signal may be determined (or set) as A₁. The offset-modulated signal may be expressed as in Equation 7.

$${\overline{s}}_{aom} [ n ] = \{ \begin{matrix}{A}_{0} exp ( j {φ}_{t} [ n ] ) & if {b}_{2} [ n ] = 0 \\ {A}_{1} exp ( j {φ}_{t} [ n ] ) & if {b}_{2} [ n ] = 1\end{matrix} \qquad [ Equation 7 ]$$

In Equation 7, s̅ₐₒₘ[n] may represent the offset-modulated signal to which the first offset modulation scheme is applied, and b_2[n]=b_(i_2) b₂[n]=bᵢ_{₂}. A₀ may be smaller than A₁.

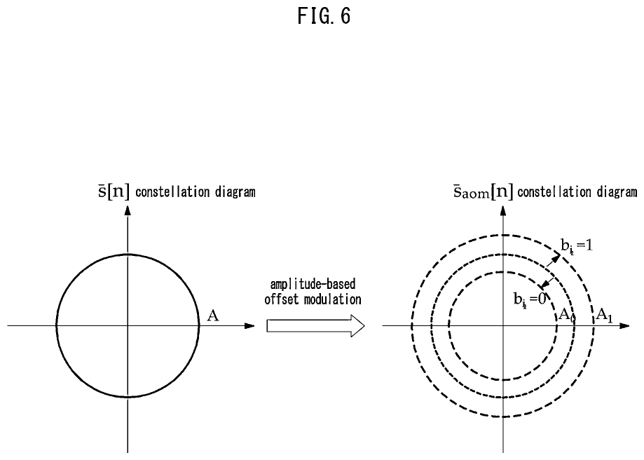

The first offset modulation scheme may be expressed as a constellation as in FIG. 6. The first offset modulation scheme be an amplitude-based offset modulation scheme as mentioned above.

FIG. 6 is a conceptual diagram illustrating a first offset modulation scheme according to exemplary embodiments of the present disclosure.

Referring to FIG. 6, when the first offset modulation scheme is applied (or performed), the offset-modulated signal s̅ₐₒₘ[n] may have its amplitude determined (or set) as either A₀ or A₁ according to each bit b₂[n] of the bit sequence bᵢ_{₂}. When each bit b₂[n] of the bit sequence bᵢ_{₂} is ‘0’, the offset-modulated signal s̅ₐₒₘ[n] may have its amplitude determined (or set) as A₀. When each bit b₂[n] of the bit sequence bᵢ_{₂} is ‘1’, the offset-modulated signal s̅ₐₒₘ[n] may have its amplitude determined (or set) as A₁. The offset-modulated signal s̅ₐₒₘ[n] may express the amplitude-based offset-modulated signal to which the first offset modulation scheme is applied. The phase-modulated signal s̅[n] obtained by performing phase modulation may have the constant amplitude A as shown in Equation 6. A₀ may be smaller than A, and A₁ may be larger than A. A₀, A₁, and A may be determined in advance according to a predefined method.

In the first offset modulation scheme. The amplitude offset modulation steps may be configured as multiple amplitude offset modulation steps including two or more steps.

In an exemplary embodiment, the multiple amplitude offset modulation steps in the first offset modulation scheme may be configured as two steps. When the multiple amplitude offset modulation steps are configured as two steps, the multiple offset modulation steps may be configured as two amplitude offset modulation steps for each individual bit of the bit sequence bᵢ_{₂}.

When each bit of the bit sequence bᵢ_{₂} has a value of {‘0’, ‘1’}, the amplitude may be determined (or configured) as {A₀, A₁}. As described above, when each bit of the bit sequence bᵢ_{₂} is ‘0’, the amplitude may be determined (or set) as A₀. When each bit of the bit sequence bᵢ_{₂} is ‘1’, the amplitude may be determined (or set) as A₁.

In another exemplary embodiment, the multiple amplitude offset modulation steps in the first offset modulation scheme may be determined (or configured) as four steps. When the multiple amplitude offset modulation steps are determined (or configured) as four steps, the multiple amplitude offset modulation steps may be determined (or configured) as four amplitude offset modulation steps for each bit pair of two bits within the bit sequence bᵢ_{₂}.

When a bit pair of the bit sequence bᵢ_{₂} has a value of {‘00’, ‘01’, ‘10’, ‘11’}, the amplitude may be determined (or set) as {A₀, A₁, A₂, A₃}. When the bit pair of the bit sequence bᵢ_{₂} is ‘00’, the amplitude may be determined (or set) as A₀, when the bit pair of the bit sequence bᵢ_{₂} is ‘01’, the amplitude may be determined (or set) as A₁, when the bit pair of the bit sequence bᵢ_{₂} is ‘10’, the amplitude may be determined (or set) as A₂, and when the bit pair of the bit sequence bᵢ_{₂} is ‘11’, the amplitude may be determined (or set) as A₃.

### Second Offset Modulation Scheme

When the second offset modulation scheme is applied (or performed) to the first communication node, the first communication node may perform modulation so that a difference value of the phase for the phase-modulated signal is used as a means of information transfer (or transmission). The phase-modulated signal may refer to the signal obtained by performing the process Tx-6 as described above. The phase-modulated signal s[n] may have the constant amplitude A as shown in Equation 6. When a phase distribution range of the phase-modulated signal s̅[n] is [−π/2, π/2), the first communication node may apply (or perform) the second offset modulation scheme.

In an exemplary embodiment, when each bit of the bit sequence bᵢ_{₂} to be applied to offset modulation is ‘0’, a phase offset of the offset-modulated signal may be determined (or set) as

$$+ \frac{π}{2} .$$

When each bit of the bit sequence bᵢ_{₂} to be applied to offset modulation is ‘1’, the phase offset of the offset-modulated signal may be determined (or set) as

$$- \frac{π}{2} .$$

The offset-modulated signal may be expressed as in Equation 8.

$${\overline{s}}_{pom} [ n ] = \{ \begin{matrix}exp ( j {φ}_{t} [ n ] + π / 2 ) & if {b}_{2} [ n ] = 0 \\ exp ( j {φ}_{t} [ n ] - π / 2 ) & if {b}_{2} [ n ] = 1\end{matrix} \qquad [ Equation 8 ]$$

In Equation 8, s̅ₚₒₘ[n] may represent the offset-modulated signal to which the second offset modulation scheme is applied, and pₜ[n] may represent the instantaneous phase signal. b₂[n] may be each bit of the bit sequence bᵢ_{₂}.

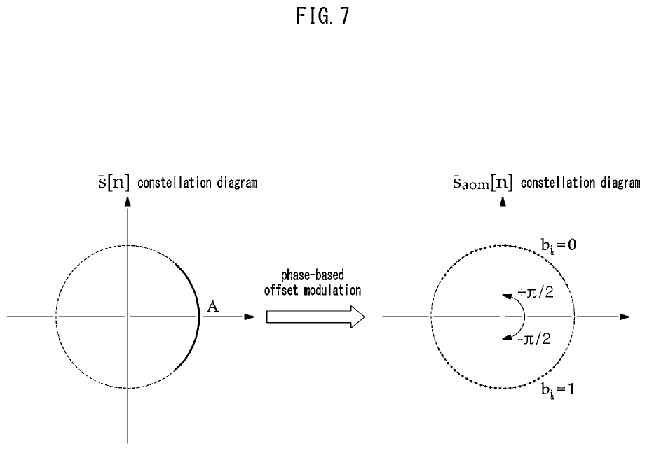

The second offset modulation scheme may be expressed as a constellation as in FIG. 7. The second offset modulation scheme may be a phase-based offset modulation scheme as mentioned above.

FIG. 7 is a conceptual diagram illustrating a second offset modulation scheme according to exemplary embodiments of the present disclosure.

Referring to FIG. 7, when the second offset modulation scheme is applied (or performed), a phase offset of the offset-modulated signal s̅ₚₒₘ[n] may be determined (or set) as either +π/2 or −π/2 according to each bit b₂[n] of the bit sequence bᵢ_{₂}. When each bit b₂[n] of the bit sequence bᵢ_{₂} is ‘0’, the phase offset of the offset-modulated signal s̅ₚₒₘ[n] may be determined (or set) as +π/2. When each bit b₂[n] of the bit sequence bᵢ_{₂} is ‘1’, the phase offset of the offset-modulated signal s̅ₚₒₘ[n] may be determined (or set) as −π/2. The offset-modulated signal s̅ₚₒₘ[n] may express the phase-based offset-modulated signal to which the second offset modulation scheme is applied. The phase-modulated signal s̅[n] obtained by performing phase modulation may be a signal distributed around a phase 0 while having a constant amplitude A, as shown in Equation 6.

In the second offset modulation scheme, the phase offset modulation steps may be configured to multiple phase offset modulation steps including two or more steps.

In an exemplary embodiment, the multiple phase offset modulation steps in the second offset modulation scheme may be configured as two steps. When configured as two phase offset modulation steps, the multiple phase offset modulation steps may be configured as two phase offset modulation steps for each bit of the bit sequence bᵢ_{₂}.

When each bit of the bit sequence bᵢ_{₂} has a value of {‘0’, ‘1’}, a phase offset may be determined (or set) as {+π/2, −π/2}. As described above, when each bit of the bit sequence bᵢ_{₂} is ‘0’, the phase offset may be determined (or set) as +π/2. When each bit of the bit sequence bᵢ_{₂} is ‘1’, the phase offset may be determined (or set) as −π/2.

In another exemplary embodiment, the multiple phase offset modulation steps in the second offset modulation scheme may be configured as four steps. When configured as four steps, the multiple phase offset modulation steps may be determined (or configured) as four phase offset modulation steps for each bit pair of two bits within the bit sequence bᵢ_{₂}.

When a bit pair of the bit sequence bᵢ_{₂} has a value of {‘00’, ‘01’, ‘10’, ‘11’}, the phase offset may be determined (or set) as one of {+π/4, +3π/4, −π/4, −3π/4}. When the bit pair of the bit sequence bᵢ_{₂} is ‘00’, the phase offset may be determined (or set) as +π/4, when the bit pair of the bit sequence bᵢ_{₂} is ‘01’, the phase offset may be determined (or set) as +3π/4, when the bit pair of the bit sequence bᵢ_{₂} is ‘10’, the phase offset may be determined (or set) as −π/4, and when the bit pair of the bit sequence bᵢ_{₂} is ‘11’, the phase offset may be determined (or set) as −3π/4.

### [Process Tx-8] Cyclic Prefix Insertion

In the process Tx-8, the first communication node may perform cyclic prefix (CP) insertion on the offset-modulated signal obtained in the process Tx-7. For example, for one symbol region of the obtained offset-modulated signal, the last N_{CP} samples may be copied and added to the front of the symbol region.

When performing CP insertion, the first communication node may obtain a transmission signal with a CP inserted for the offset-modulated signal. The transmission signal with a CP inserted may be transmitted to the second communication node in a passband through a transmission antenna. When the transmission signal with a CP inserted passes through a wireless channel, the transmission signal with a CP inserted may be affected in various ways. The various effects may include multipath fading, Doppler spreading, time/frequency error, phase noise, white noise, etc.

The first communication node may determine whether to apply (or perform) the process Tx-8 according to predefined configuration information (e.g. supported communication standards). If it is determined that the first communication node applies (or performs) the process Tx-8, the first communication node may apply (or perform) the process Tx-8. For example, if the first communication node supports 5G NR communication standards, the first communication node may apply (or perform) the process Tx-8. The first communication node may transmit the transmission signal with CP inserted to the second communication node through an antenna.

If it is determined that the process Tx-8 is not applied to the first communication node, the first communication node may not apply (or perform) the process Tx-8. The first communication node may transmit the offset-modulated signal to the second communication node through an antenna. The offset-modulated signal may refer to the signal obtained by performing the process Tx-7.

As illustrated in FIG. 3, the amplitude and phase offset-based transmission unit 310 may include an information bit separation block. In the first communication node, the process Tx-1 may be performed in the cyclic prefix insertion block included in the amplitude and phase offset-based transmission unit 310. The cyclic prefix insertion block may be referred to as a cyclic prefix inserter.

### <Second Communication Node: Reception Method of Amplitude and Phase Offset-Based Modulated Signal>

When the amplitude and phase offset-based modulation method proposed in the present disclosure is applied to the first communication node and the second communication node, as illustrated in FIG. 3, the first communication node may include the amplitude and phase offset-based transmission unit 310. The second communication node may include the amplitude and phase offset-based reception unit 320. In the second communication node, the amplitude and phase offset-based reception unit 320 may perform the following operations.

### [Process Rx-1] Time/Frequency Synchronization

In the process Rx-1, the second communication node may receive a signal transmitted by the first communication node through a reception antenna. The signal received by the second communication node may be converted to a baseband. The second communication node may perform time and frequency synchronization using the reception signal converted to the baseband. The reception signal converted to the baseband may be expressed as r[n].

As illustrated in FIG. 3, the transmission signal of the first communication node may be transmitted to the second communication node through a wireless channel. The transmission signal of the first communication node, which is received by the second communication node, may include phase noise and white noise. The white noise may refer to additive white Gaussian noise (AWGN).

As illustrated in FIG. 3, the amplitude and phase offset-based reception unit 320 may include a time/frequency synchronization block. In the second communication node, the process Rx-1 may be performed in the time/frequency synchronization block included in the amplitude and phase offset-based reception unit 320. The time/frequency synchronization block may be referred to as a time/frequency synchronizer.

Hereinafter, a channel estimation method between the first communication node and the second communication node for the reception signal converted to the baseband will be described.

### [Process Rx-2] Channel Estimation

In the process Rx-2, the second communication node may perform channel estimation on the reception signal obtained in the process Rx-1. The second communication node may obtain channel information between the first communication node and the second communication node through channel estimation. For example, if the first communication node is a base station, the second communication node may obtain cell information by performing time/frequency synchronization. The time/frequency synchronization may refer to downlink (DL) synchronization. The time/frequency synchronization process may refer to the above-described process Rx-1.

As illustrated in FIG. 3, the amplitude and phase offset-based reception unit 320 may include a channel estimation block. In the second communication node, the process Rx-2 may be performed in the channel estimation block included in the amplitude and phase offset-based reception unit 320. The channel estimation block may be referred to as a channel estimator.

Hereinafter, a method of compensating for signal distortion caused by the wireless channel between the first communication node and the second communication node using channel information will be described.

### [Process Rx-3] Channel Equalization

In the process Rx-3, the second communication node may perform channel equalization using the channel information obtained in the process Rx-2. When channel equalization is performed in the second communication node, the second communication node may compensate for signal distortion caused by the wireless channel between the first communication node and the second communication node for the reception signal. Since the transmission signal of the first communication node is transmitted through the wireless channel, signal distortion may occur during the transmission process. The second communication node may compensate for distortion in the reception signal using the channel information in order to correctly receive the distorted signal. The second communication node may perform channel equalization by applying frequency domain equalization (FDE).

The second communication node may determine whether CP removal is applied according to predefined configuration information (e.g. supported standards). If it is determined that the second communication node applies CP removal, in the process Rx-3, the second communication node may further perform CP removal on the reception signal \hat{r}[n] for which signal distortion due to the wireless channel between the first communication node and the second communication node is compensated.

As illustrated in FIG. 3, the amplitude and phase offset-based reception unit 320 may include a channel equalization block. In the second communication node, the process Rx-2 may be performed in the channel equalization block included in the amplitude and phase offset-based reception unit 320. The channel equalization block may be referred to as a channel equalizer.

### [Process Rx-4] Offset Demodulation

In the process Rx-4, the second communication node may perform offset demodulation on the reception signal \hat{r}[n] obtained in the process Rx-3. If the offset demodulation is successfully performed, the second communication node may obtain (or extract) a first demodulated bit sequence \hat{b}ᵢ_{₂} composed of N_{b}⁽²⁾ bits. It may be assumed that the number of first demodulated bits N_{b}⁽²⁾ is preset. The reception signal \hat{r}[n] may refer to the reception signal in which channel distortion between the first communication node and the second communication node is compensated.

In the process Tx-7, depending on the offset modulation scheme applied (or performed) by the first communication node to the phase-modulated signal, the second communication node may apply (or perform) one of a first offset demodulation scheme or a second offset demodulation scheme. When the first communication node applies (or performs) the first offset modulation scheme, the second communication node may apply (or perform) the first offset demodulation scheme. When the first communication node applies (or performs) the second offset modulation scheme, the second communication node can apply (or perform) the second offset demodulation scheme.

As described above, the first offset modulation scheme may be an amplitude-based offset modulation scheme. The second offset modulation scheme may be a phase-based offset modulation scheme. The first offset demodulation scheme may be an amplitude-based offset demodulation scheme. The second offset demodulation scheme may be a phase-based offset demodulation scheme.

As illustrated in FIG. 3, the amplitude and phase offset-based reception unit 320 may include an offset demodulation block. In the second communication node, the process Rx-4 may be performed in the offset demodulation block included in the amplitude and phase offset-based reception unit 320. The offset demodulation block may be referred to as an offset demodulator.

### First Offset Demodulation Scheme

In the first offset demodulation scheme, the second communication node may obtain (or extract) the first demodulated bit sequence \hat{b}ᵢ_{₂} based on the amplitude offset. After the first demodulated bit sequence \hat{b}ᵢ_{₂} is obtained (or extracted), the second communication node may obtain the reception signal in which the applied amplitude offset modulation is removed.

### Method for Obtaining the First Demodulated Bit Sequence

When the second communication node applies (or performs) the first offset demodulation scheme, the second communication node may obtain (or extract) the first demodulated bit sequence \hat{b}ᵢ_{₂} comprising N_{b}⁽²⁾ bits by utilizing the amplitude offset difference in the reception signal \hat{r}[n].

In an exemplary embodiment, the second communication node may obtain (or extract) the first demodulated bit sequence \hat{b}ᵢ_{₂} according to a result of comparing an amplitude |\hat{r}|[n]| of the reception signal \hat{r}[n] with an amplitude threshold Aₜₕ, as shown in Equation 9. One bit may correspond to the first demodulated bit sequence \hat{b}ᵢ_{₂}. The configured offset demodulation information may include the amplitude threshold Aₜₕ. The amplitude threshold Aₜₕ may be set to the amplitude A of the phase-modulated signal or a middle value of the amplitudes A₀ and A₁ of the offset-modulated signal.

$${\hat{b}}_{{i}_{2}} = \{ \begin{matrix}0 & if \vert \hat{r} [ n ] \vert \leq {A}_{th} \\ 1 & if \vert \hat{r} [ n ] \vert > {A}_{th}\end{matrix} \qquad [ Equation 9 ]$$

In Equation 9, \hat{r}[n] may represent the reception signal with compensated channel distortion, and |\hat{r}[n]| may represent the amplitude of the reception signal \hat{r}[n].

If the amplitude |\hat{r}[n]| of the reception signal \hat{r}[n] is equal to or less than the amplitude threshold Aₜₕ, the first demodulated bit sequence \hat{b}ᵢ_{₂} may correspond to one bit ‘0’. If the amplitude |\hat{r}[n]| of the reception signal \hat{r}[n] exceeds the amplitude threshold Aₜₕ, the first demodulated bit sequence \hat{b}ᵢ_{₂} may correspond to one bit ‘1’.

In another exemplary embodiment, the second communication may obtain (or extract) the first demodulated bit sequence \hat{b}ᵢ_{₂} according to a result of comparison between the reception signal \hat{r}[n] and three amplitude thresholds Aₜₕ₀, Aₜₕ₁, and Aₜₕ₂. A bit pair composed of two bits may correspond to the first demodulated bit sequence \hat{b}ᵢ_{₂}. The configured offset demodulation information may include the three amplitude thresholds Aₜₕ₀, Aₜₕ₁, and Aₜₕ₂.

If the amplitude |\hat{r}[n]| of the reception signal \hat{r}[n] is smaller than the amplitude threshold Aₜₕ₀, the first demodulated bit sequence \hat{b}ᵢ_{₂} may correspond to a bit pair ‘00’. When the amplitude |\hat{r}[n]| of the reception signal \hat{r}[n] is greater than the amplitude threshold Aₜₕ₀ and less than the amplitude threshold Aₜₕ₁, the first demodulated bit sequence \hat{b}ᵢ_{₂} may correspond to a bit pair ‘01’. When the amplitude |\hat{r}[n]| of the reception signal \hat{r}[n] is greater than the amplitude threshold Aₜₕ₁ and less than the amplitude threshold Aₜₕ₂, the first demodulated bit sequence bᵢ_{₂} may correspond to a bit pair ‘10’. When the amplitude |\hat{r}[n]| of the reception signal \hat{r}[n] is greater than the amplitude threshold Aₜₕ₂, the first demodulated bit sequence \hat{b}ᵢ_{₂} may correspond to a bit pair ‘11’.

When the first offset demodulation scheme is applied to the second communication node, as described above, one bit or a bit pair including two bits may correspond to the first demodulated bit sequence \hat{b}ᵢ_{₂}. This is merely for convenience of description and is not limited thereto, and a bit group including three or more bits may correspond to the first demodulated bit sequence \hat{b}ᵢ_{₂}, and the configured offset demodulation information may include seven or more amplitude thresholds.

When the second communication node applies (or performs) the first offset demodulation scheme, the second communication node may perform recovery for the amplitude offset modulation applied to the reception signal \hat{r}[n]. When the second communication node performs recovery for the amplitude offset modulation applied to the reception signal \hat{r}[n], the second communication node may apply (or perform) at least one the following schemes. The recovery for the applied amplitude offset modulation may be performed at the second communication node after obtaining the first demodulated bit sequence \hat{b}ᵢ_{₂}.

### First Amplitude Offset Recovery Scheme

After the first demodulated bit sequence \hat{b}ᵢ_{₂} is obtained (or extracted), the second communication node may apply (or perform) a first amplitude offset recovery scheme to the reception signal \hat{r}[n] to obtain an amplitude-normalized reception signal. The amplitude-normalized reception signal \hat{r}_{αr}[n] may be expressed as in Equation 10.

$${\hat{r}}_{a r} [ n ] = \hat{r} [ n ] / \vert \hat{r} [ n ] \vert \qquad [ Equation 10 ]$$

As shown in Equation 10, the amplitude-normalized reception signal \hat{r}_{αr}[n] may be a normalized reception signal so that the amplitude becomes 1.

### Second Amplitude Offset Recovery Scheme

After the first demodulated bit sequence \hat{b}ᵢ_{₂} is obtained (or extracted), the second communication node may apply (or perform) the second amplitude offset recovery scheme to the reception signal \hat{r}[n] according to information of the first demodulated bit sequence \hat{b}ᵢ_{₂} to obtain the reception signal \hat{r}_{αr}[n] with the applied amplitude offset canceled. The reception signal \hat{r}_{αr}[n] with the applied amplitude offset canceled may be expressed as in Equation 11.

$${\hat{r}}_{a r} [ n ] = \{ \begin{matrix}\hat{r} [ n ] \frac{A}{{A}_{0}} & if {\hat{b}}_{{i}_{2}} = 0 \\ \hat{r} [ n ] \frac{A}{{A}_{1}} & if {\hat{b}}_{{i}_{2}} = 1\end{matrix} \qquad [ Equation 11 ]$$

As shown in Equation 11, one bit may correspond to the first demodulated bit sequence \hat{b}ᵢ_{₂}. When the first demodulated bit sequence \hat{b}ᵢ_{₂} is ‘1’, the reception signal \hat{r}_{αr}[n] with the applied amplitude offset canceled may be a signal obtained from the reception signal \hat{r}[n] by increasing the amplitude of the reception signal \hat{r}[n] by a ratio between A and A₀. When the first demodulated bit sequence \hat{b}ᵢ_{₂} is ‘0’, the reception signal \hat{r}_{αr}[n] with the applied amplitude offset canceled may be a signal obtained from the reception signal \hat{r}[n] by decreasing the amplitude of the reception signal \hat{r}[n] by a ratio between A and A₁.

### Third Amplitude Offset Recovery Scheme

The second communication node may obtain the reception signal \hat{r}[n] without compensating for the applied amplitude offset modulation on the reception signal \hat{r}[n]. The reception signal \hat{r}_{αr}[n] may be expressed as in Equation 12.

$${\hat{r}}_{a r} [ n ] = \hat{r} [ n ] \qquad [ Equation 12 ]$$

When the first amplitude offset compensation method is applied, as described above, one bit may correspond to the first demodulated bit sequence \hat{b}ᵢ_{₂}. This is merely for convenience of description and the present disclosure is not limited thereto, and a bit group including two or more bits may correspond to the demodulated bit sequence \hat{b}ᵢ_{₂}.

### Second Offset Demodulation Scheme

In the second offset demodulation method, the second communication node may obtain (or extract) the information bit sequence \hat{b}ᵢ_{₂} based on the phase offset. After the information bit sequence \hat{b}ᵢ_{₂} is obtained (or extracted), the second communication node may obtain the reception signal in which the phase offset modulation is compensated.

### Method for Obtaining Information Bit Sequence of Phase Offset Modulation

When the second offset demodulation scheme is applied to the second communication node, the second communication node may extract the information bit sequence \hat{b}ᵢ_{₂} comprising N_{b}⁽²⁾ bits from the reception signal \hat{r}[n] based on a phase offset difference. As described above, it may be assumed that the number N_{b}⁽²⁾ of bits constituting the information bit sequence is preset.

In an exemplary embodiment, the second communication node may extract the information bit sequence \hat{b}ᵢ_{₂} from the reception signal \hat{r}[n] as shown in Equation 13. One bit may correspond to the information bit sequence \hat{b}ᵢ_{₂}. The configured offset demodulation information may include one phase threshold Pₜₕ, and the phase threshold Pₜₕ may be π.

$${\hat{b}}_{{i}_{2}} = \{ \begin{matrix}0 , & 0 \leq arg \hat{r} [ n ] < π \\ 1 , & - π \leq arg \hat{r} [ n ] < 0\end{matrix} \qquad [ Equation 13 ]$$

In Equation 13, \hat{r}[n] may represent the reception signal after performing channel equalization, and arg \hat{r}[n] may represent the phase of the reception signal \hat{r}[n]. The phase threshold Pₜₕ may be π.

If the phase arg \hat{r}[n] of the reception signal \hat{r}[n] is within a range from 0 to the phase threshold Pₜₕ (i.e. the phase arg \hat{r}[n] of the reception signal \hat{r}[n] is [0,π)), the information bit sequence \hat{b}ᵢ_{₂} may correspond to ‘1’. Otherwise (if the phase arg \hat{r}[n] of the reception signal \hat{r}[n] is [−π, 0)), the information bit sequence \hat{b}ᵢ_{₂} may correspond to ‘0’.

In another exemplary embodiment, the second communication node may extract the information bit sequence \hat{b}ᵢ_{₂} from the reception signal \hat{r}[n]. A bit pair may correspond to the information bit sequence \hat{b}ᵢ_{₂}. The configured offset demodulation information may include three phase thresholds Pₜₕ₀, Pₜₕ₁, and Pₜₕ₂. The phase threshold Pₜₕ₀ may be π/2, the phase threshold Pₜₕ₁ may be π, and Pₜₕ₂ may be −π/2.

If the phase arg \hat{r}[n] of the reception signal \hat{r}[n] is contained in [0,π/2), the information bit sequence \hat{b}ᵢ_{₂} may correspond to a bit pair ‘00’. If the phase arg \hat{r}[n] of the reception signal \hat{r}[n] is contained in [π/2,π], the information bit sequence \hat{b}ᵢ_{₂} may correspond to a bit pair ‘01’. If the phase arg \hat{r}[n] of the reception signal \hat{r}[n] is contained in [−π/2,0], the information bit sequence \hat{b}ᵢ_{₂} may correspond to a bit pair ‘10’. If the phase arg \hat{r}[n] of the reception signal \hat{r}[n] is included in [−π,−π/2], the information bit sequence \hat{b}ᵢ_{₂} may correspond to a bit pair ‘11’.

When the second offset demodulation scheme is applied to the second communication node, as described above, the information bit sequence \hat{b}ᵢ_{₂} may correspond to one bit or may correspond to a bit pair including two bits. This is merely for convenience of description and the present disclosure is not limited thereto. The information bit sequence \hat{b}ᵢ_{₂} may correspond to a bit group including three or more bits, and the configured offset demodulation information may include seven or more phase thresholds.

### First Phase Offset Recovery Scheme

After the bit sequence \hat{b}ᵢ_{₂} is extracted, the second communication node may obtain a reception signal \hat{r}ₚᵣ[n] with the compensated phase offset for the reception signal \hat{r}[n] according to information of the extracted bit sequence \hat{b}ᵢ_{₂}. The reception signal \hat{r}ₚᵣ[n] with the phase offset compensated may be expressed as in Equation 14.

$${\hat{r}}_{p r} [ n ] = \{ \begin{matrix}\hat{r} [ n ] exp ( j π / 2 ) & if {\hat{b}}_{{i}_{2}} = 0 \\ \hat{r} [ n ] exp ( - j π / 2 ) & if {\hat{b}}_{{i}_{2}} = 0\end{matrix} \qquad [ Equation 14 ]$$

As shown in Equation 14, one bit may correspond to the information bit sequence \hat{b}ᵢ_{₂}. If the obtained (or extracted) bit sequence \hat{b}ᵢ_{₂} is ‘0’, the reception signal \hat{r}ₚᵣ[n] with the phase offset compensated may be a signal obtained by compensating the phase of the reception signal \hat{r}[n] by +π/2. If the obtained (or extracted) bit sequence bᵢ_{₂} is ‘1’, the reception signal \hat{r}ₚᵣ[n] with the phase offset compensated may be a signal obtained by compensating the phase of the reception signal \hat{r}[n] by −π/2.

When the first phase offset recovery scheme of the phase offset modulation is applied, as described above, one bit may correspond to the restored bit sequence bᵢ_{₂}. This is merely for convenience of description and the present disclosure is not limited thereto. A bit group including two or more bits may correspond to the restored bit sequence bᵢ_{₂}.

### [Process Rx-5] Phase Demodulation

In the process Rx-5, the second communication node may perform phase demodulation on the offset-demodulated signal \hat{r}_{αr}[n] or \hat{r}ₚᵣ[n] obtained in the process Rx-4. The offset-demodulated signal \hat{r}_{αr}[n] may be an offset-demodulated signal obtained by applying (or performing) the first offset demodulation scheme in the process Rx-4. The offset-demodulated signal \hat{r}ₚᵣ[n] may be an offset-demodulated signal obtained by applying (or performing) the second offset demodulation scheme in the process Rx-4.

Depending on the offset demodulation method applied (or performed) to the second communication node in the process Rx-4, the second communication node may apply (or perform) one of a first phase demodulation scheme or a second phase demodulation scheme. When the first offset demodulation scheme is applied to the second communication node, the second communication node may apply (or perform) the first phase demodulation scheme. When the second offset demodulation scheme is applied to the second communication node, the second communication node may apply (or perform) the second phase demodulation scheme. As described above, the first offset modulation scheme may be an amplitude-based offset modulation scheme, and the second offset modulation scheme may be a phase-based offset modulation scheme.

The second communication node may apply (or perform) the first phase demodulation scheme to the offset-demodulated signal \hat{r}_{αr}[n] to obtain the instantaneous phase signal \hat{φ}ₜ[n]. The second communication node may apply (or perform) the second phase demodulation scheme to the offset-demodulated signal \hat{r}ₚᵣ[n] to obtain the instantaneous phase signal \hat{φ}ₜ[n]. Thereafter, in order to make a difference of the consecutive instantaneous phase signals \hat{φ}ₜ[n] within [−π, π], the second communication node may perform phase unwrapping.

As illustrated in FIG. 3, the amplitude and phase offset-based reception unit 320 may include a phase demodulation block. In the second communication node, the process Rx-5 may be performed in the phase demodulation block included in the amplitude and phase offset-based reception unit 320. The phase demodulation block may be referred to as a phase demodulator.

### First Phase Demodulation Scheme

In the first phase demodulation scheme, the second communication node may obtain the instantaneous phase signal \hat{φ}ₜ[n] for the offset-demodulated signal \hat{r}_{αr}[n]. The offset-demodulated signal \hat{r}_{αr}[n] may be a signal obtained by applying the first offset demodulation scheme.

In the first phase demodulation scheme, the instantaneous phase signal \hat{φ}ₜ[n] may be expressed as an inverse tangent function of a ratio of an imaginary part and a real part of the offset-demodulated signal \hat{r}_{αr}[n] as in Equation 15.

$${\hat{φ}}_{t} [ n ] = arg {\hat{r}}_{a r} [ n ] = arc tan \frac{Im \{ {\hat{r}}_{a r} [ n ] \}}{Re \{ {\hat{r}}_{a r} [ n ] \}} \qquad [ Equation 15 ]$$

In Equation 15, \hat{r}_{αr}[n] may represent the offset-demodulated signal obtained by applying the first offset demodulation scheme. Im{\hat{r}_{αr}[n]} may represent the imaginary part of \hat{r}_{αr}[n], and Re{\hat{r}_{αr}[n]} may represent the imaginary part of \hat{r}_{αr}[n].

### Second Phase Demodulation Scheme

In the second phase demodulation scheme, the second communication node may obtain the instantaneous phase signal \hat{φ}ₜ[n] for the offset-demodulated signal \hat{r}ₚᵣ[n]. The offset-demodulated signal \hat{r}ₚᵣ[n] may be a signal obtained by applying the second offset demodulation scheme.

In the second phase demodulation scheme, the instantaneous phase signal \hat{φ}ₜ[n] may be expressed as an inverse tangent function of a ratio of an imaginary part and a real part of the offset-demodulated signal \hat{r}ₚᵣ[n], as in Equation 16.

$${\hat{φ}}_{t} [ n ] = arg {\hat{r}}_{p r} [ n ] = arc tan \frac{Im \{ {\hat{r}}_{p r} [ n ] \}}{Re \{ {\hat{r}}_{p r} [ n ] \}} \qquad [ Equation 16 ]$$

In Equation 16, \hat{r}ₚᵣ[n] may represent the offset-demodulated signal obtained by applying the second offset demodulation scheme. Im{\hat{r}ₚᵣ[n]} may represent the imaginary part of \hat{r}ₚᵣ[n], and Re{\hat{r}ₚᵣ[n]]} may represent the real part of fₚᵣ[n].

Hereinafter, a frequency demodulation process for the instantaneous phase signal \hat{φ}ₜ[n] will be described.

### [Process Rx-6] Frequency Demodulation

In the process Rx-6, the second communication node may perform frequency demodulation on the instantaneous phase signal \hat{φ}ₜ[n] obtained in the process Rx-5. If the frequency demodulation is performed successfully, the second communication node may obtain an instantaneous frequency signal \hat{f}[n].

Depending on the frequency modulation scheme applied (or performed) by the first communication node to the time-domain signal in the process Tx-5, the second communication node may apply (or perform) a first frequency demodulation scheme or a second frequency demodulation scheme. When the first communication node applies (or performs) the first frequency modulation scheme, the second communication node may apply the first frequency demodulation scheme. When the first communication node applies (or performs) the second frequency modulation scheme, the second communication node may apply the second frequency demodulation scheme.

In the process Tx-5, the first frequency modulation scheme may obtain the instantaneous phase signal by calculating a cumulative sum for the time-domain signal as shown in Equation 4. The second frequency modulation scheme may obtain the instantaneous phase signal without applying (or performing) frequency modulation to the time-domain signal as shown in Equation 5.

As illustrated in FIG. 3, the amplitude and phase offset-based reception unit 320 may include a frequency demodulation block. In the second communication node, the process Rx-6 may be performed in the frequency block included in the amplitude and phase offset-based reception unit 320. The frequency demodulation block may be referred to as a frequency demodulator.

### First Frequency Demodulation Scheme

In the first frequency demodulation scheme, the second communication node may obtain an instantaneous frequency signal \hat{f}[n] through a backward difference operation on the instantaneous phase signal \hat{φ}ₜ[n]. The instantaneous frequency signal \hat{f}[n] may be expressed using a backward difference operation.

$$\begin{matrix}\hat{f} [ n ] = \frac{1}{2 π} ∇ {\hat{φ}}_{t} [ n ] , \\ \hat{f} [ 0 ] = \frac{1}{2 π} ( {\hat{φ}}_{t} [ 0 ] - {\hat{φ}}_{t} [ N - 1 ] )\end{matrix} \qquad [ Equation 17 ]$$

In Equation 17, ∇(delta) may represent the backward difference operation, and \hat{f}[0] may represent an initial instantaneous frequency signal.

### Second Frequency Demodulation Scheme

In the second frequency demodulation scheme, the second communication node may obtain an instantaneous frequency signal \hat{f}[n] without applying (or performing) frequency demodulation to the instantaneous phase signal \hat{φ}ₜ[n]. The instantaneous frequency signal \hat{f}[n] may be used only with the instantaneous phase signal \hat{φ}ₜ[n] without using the previous instantaneous phase signal (e.g. the instantaneous phase signal \hat{φ}ₜ[n−1]), as in Equation 18.

$$\hat{f} [ n ] = \frac{1}{2 π} {\hat{φ}}_{t} [ n ] \qquad [ Equation 18 ]$$

In Equation 18, \hat{φ}ₜ[n] may represent the instantaneous phase signal.

Hereinafter, a process of transforming the instantaneous frequency signal \hat{f}[n] to the frequency domain will be described.

### [Process Rx-7] Time-to-Frequency Domain Transform

In the process Rx-7, the second communication node may perform time-to-frequency domain transform on the instantaneous frequency signal \hat{f}[n] obtained in the process Rx-6.

When the time-to-frequency domain transform is successfully performed, the second communication node may obtain a frequency-domain signal \hat{X}[k] transformed to the frequency domain.

Depending on the frequency-to-time domain transform scheme applied (or performed) by the first communication node to the frequency-domain signal in the process Tx-4, the second communication node may apply (or perform) one of a first time-to-frequency domain transform scheme and a second time-to-frequency domain transform scheme. When the first communication node applies (or uses) the first frequency-to-time domain transform scheme to the frequency-domain signal, the second communication node may apply (or perform) the first time-to-frequency transform scheme. When the first communication node applies (or uses) the second frequency-to-time domain transform scheme to the frequency-domain signal, the second communication node may apply (or perform) the second time-to-frequency transform scheme.

As described above, in the first frequency-to-time domain transform scheme of the process Tx-4, IDFT may be applied (or performed). In the first time-to-frequency transform scheme, DFT may be applied (or performed). In the second frequency-to-time domain transform scheme of the process Tx-4, IDCT or IDST may be applied (or performed). In the second time-to-frequency transform scheme, discrete cosine transform (DCT) or discrete sine transform (DST) may be applied (or performed). When IDCT is applied (or performed) in the second frequency-to-time domain transform scheme of the process Tx-4, DCT may be applied (or performed) in the second time-to-frequency domain transform scheme. When IDST is applied (or performed) in the first frequency-to-time domain transform scheme of the process Tx-4, DST may be applied (or performed) in the second time-to-frequency domain transform scheme.

As illustrated in FIG. 3, the amplitude and phase offset-based reception unit 320 may include a frequency demodulation block. In the second communication node, the process Rx-6 may be performed in the frequency demodulation block included in the amplitude and phase offset-based reception unit 320. The frequency demodulation block may be referred to as a frequency demodulator.

### First Time-to-Frequency Domain Transform Scheme

In the first time-to-frequency domain transform scheme, the second communication node may obtain a frequency-domain signal \hat{X}[k] for an instantaneous frequency signal \hat{f}[n]. The instantaneous frequency signal \hat{f}[n] may be a signal obtained by applying one of the first frequency demodulation scheme or the second frequency demodulation scheme.

As described above, in the first time-to-frequency domain transform scheme, DFT may be applied. The frequency-domain signal \hat{X}[k] may be expressed as in Equation 19.

$$\hat{X} [ k ] = \frac{\sqrt{{N}_{a}}}{m N} {\sum }_{n = 0}^{N - 1} \hat{f} [ n ] {e}^{- j \frac{2 π k n}{N}} \qquad [ Equation 19 ]$$

In Equation 19, N may represent the DFT size. Nₐ may represent the number of subcarriers. m may represent a modulation index.

In the first time-to-frequency domain transform scheme. The DFT process may be replaced with a fast Fourier transform (FFT) process. The FFT size N may be a power of 2.

### Second Time-to-Frequency Domain Transform Scheme

In the second time-to-frequency domain transform scheme, the second communication node may obtain a frequency-domain signal \hat{X}[k] for an instantaneous frequency signal \hat{f}[n]. The instantaneous frequency signal \hat{f}[n] may be a signal obtained by applying one of the first frequency demodulation scheme or the second frequency demodulation scheme.

In the second time-to-frequency domain transform scheme, the frequency-domain signal \hat{X}[k] may be expressed as in Equation 20 or Equation 21.

$$\hat{X} [ k ] = \frac{2 \sqrt{{N}_{a}}}{m N} {\sum }_{n = 0}^{N - 1} \hat{f} [ n ] cos ( \frac{π}{2 N} n ( 2 k + 1 ) ) \qquad [ Equation 20 ]$$

As shown in Equation 20, the second communication node may obtain the frequency-domain signal \hat{X}[k] by applying (or performing) DCT on the instantaneous frequency signal \hat{f}[n].

$$\hat{X} [ k ] = \frac{\sqrt{{N}_{a}}}{m} \frac{N}{2} {\sum }_{k = 0}^{N - 1} \hat{f} [ n ] sin ( \frac{π ( n + 1 ) ( k + 1 )}{N + 1} ) \qquad [ Equation 21 ]$$

As shown in Equation 21, the second communication node may obtain the frequency-domain signal \hat{X}[k] by performing DST on the instantaneous frequency signal \hat{f}[n].

When the first communication node applies (or performs) IDCT to transform the frequency-domain signal into the time-domain signal in the process Tx-4, the second communication node may obtain the frequency-domain signal \hat{X}[k] by applying (or performing) DCT on the instantaneous frequency signal \hat{f}[n]. When the first communication node applies (or performs) IDST to transform the frequency-domain signal into the time-domain signal in the process Tx-4, the second communication node may obtain the frequency-domain signal \hat{X}[k] by applying (or performing) DST on the instantaneous frequency signal \hat{f}[n].

### [Process Rx-8] Subcarrier Deallocation

In the process Rx-8, the second communication node may perform subcarrier deallocation on the frequency-domain signal \hat{X}[k] obtained in the process Rx-7. If the subcarrier deallocation is successfully performed, the second communication node may obtain a complex signal sequence comprising N₃ symbols. As described above, the bit sequences bᵢ_{₁} comprising N_{b}⁽¹⁾ bits, which is separated in the process Tx-1, may be converted into the QAM-modulated signal comprising Nₛ=N_{b}⁽¹⁾/log₂ M QAM modulated symbols in the process Tx-2.

Depending on the subcarrier allocation scheme applied (or performed) by the first communication node for the QAM-modulated signal in the process Tx-4, the second communication node may apply (or perform) one of a first subcarrier deallocation scheme and a second subcarrier deallocation scheme. When the first communication node applies (or performs) the first subcarrier allocation scheme, the second communication node may apply (or perform) the first subcarrier deallocation scheme. When the first communication node applies (or performs) the second subcarrier allocation scheme, the second communication node may apply (or perform) the second subcarrier deallocation scheme.

As illustrated in FIG. 3, the amplitude and phase offset-based reception unit 320 may include a subcarrier deallocation block. In the second communication node, the process Rx-7 may be performed in the subcarrier deallocation block included in the amplitude and phase offset-based reception 320. The subcarrier deallocation block may be referred to as a subcarrier deallocator.

### First Subcarrier Deallocation Scheme

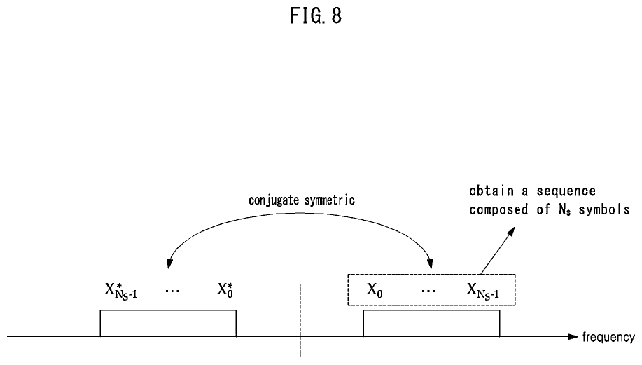

When the first subcarrier allocation scheme is applied to the first communication node, the frequency-domain signal \hat{X}[k] in the second communication node may be conjugate symmetric. In the subcarrier deallocation process for the frequency-domain signal \hat{X}[k], the second communication node may obtain a complex sequence comprising Nₛ symbols as illustrated in FIG. 8.

FIG. 8 is a conceptual diagram illustrating a first subcarrier deallocation scheme according to exemplary embodiments of the present disclosure.

Referring to FIG. 8, the first communication node may apply the first subcarrier allocation scheme to transmit the transmission signal to the second communication node. The second communication node may receive the transmission signal to which the first subcarrier allocation scheme is applied from the first communication node. The transmission signal to which the first subcarrier allocation scheme is applied may be conjugate symmetric. In the subcarrier deallocation process on the signal \hat{X}[k] converted to the frequency domain, the second communication node may apply a scheme of obtaining a complex signal sequence composed of Nₛ complex symbols. In FIG. 8, for convenience of description, it is illustrated that the Nₛ complex symbols are obtained using the second region among the first region or the second region based on the center of the entire subcarrier region, but the present disclosure is not limited thereto. The first region may be a region located on the left side based on the center of the entire subcarrier region. The second region may be a region located on the right side based on the center of the entire subcarrier region. The Nₛ complex symbols may be obtained using the first region located on the left side of the center of the entire subcarrier region and/or the second region located on the right side of the center of the entire subcarrier region.

Hereinafter, the second subcarrier deallocation scheme for the frequency-domain signal \hat{X}[k] will be described.

### Second Subcarrier Deallocation Scheme

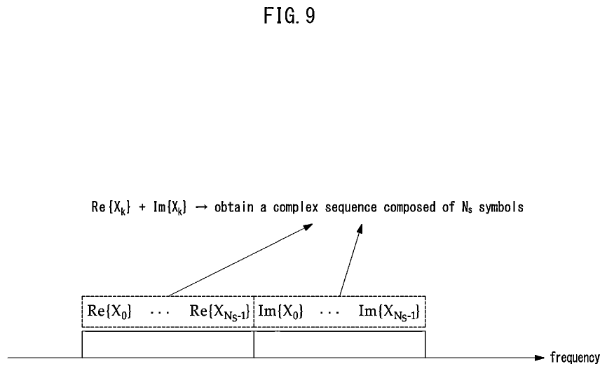

When the second subcarrier allocation scheme is applied to the first communication node, the reception signal at the second communication node may include a first part and a second part. The first part may be a real part of the reception signal in the frequency domain. The second part may be an imaginary part of the reception signal in the frequency domain. In the subcarrier deallocation process for the signal \hat{X}[k] converted to the frequency domain, the second communication node may individually obtain the first part and the second part as illustrated in FIG. 9. The individually obtained first part and second part may be combined into a complex signal.

FIG. 9 is a conceptual diagram illustrating a second subcarrier deallocation scheme according to exemplary embodiments of the present disclosure.

Referring to FIG. 9, the first communication node may apply the second subcarrier allocation scheme to transmit the transmission signal to the second communication node. The second communication node may receive the transmission signal to which the second subcarrier allocation scheme is applied from the first communication node. The transmission signal to which the second subcarrier allocation scheme is applied may include a first part and a second part. The first part may be a signal corresponding to a real part of the transmission signal in the frequency domain. The second part may be a signal corresponding to an imaginary part of the transmission signal in the frequency domain. The second communication node may individually obtain the first part and the second part by applying (or performing) subcarrier deallocation to the frequency-domain signal \hat{X}[k]. The second communication node may combine the individually obtained first part and the second part into a complex signal sequence.

Hereinafter, a QAM demodulation method for the complex signal sequence obtained in the process Rx-8 will be described.

### [Process Rx-9] QAM Demodulation

In the process Rx-9, the second communication node may perform a QAM demodulation process on the complex signal sequence obtained in the process Rx-8 to obtain a bit sequence \hat{b}ᵢ_{₁}. The subcarrier deallocation process may refer to the process Tx-8 described above.

The second communication node may perform a QAM demodulation process according to the modulation order applied to the QAM modulation process (e.g. process TX-1) in the first communication node to obtain (or extract) the bit sequence bᵢ_{₁}.

As illustrated in FIG. 3, the amplitude and phase offset-based reception unit 320 may include a QAM demodulation block. In the second communication node, the process Rx-9 may be performed in the QAM demodulation block included in the amplitude and phase offset-based reception unit 320. The QAM demodulation block may be referred to as a QAM demodulator.

### [Process Rx-10] Information Bit Reassembly

In a process Rx-10, the second communication node may perform information bit reassembly on the bit sequence \hat{b}ᵢ_{₁} obtained in the process Rx-4 and the bit sequence \hat{b}ᵢ_{₂} obtained in the process Rx-9. When the information bit reassembly is successfully performed, the second communication node may obtain (or extract) a demodulated bit sequence \hat{b}ᵢ.

As illustrated in FIG. 3, the amplitude and phase offset-based reception unit 320 may include an information bit reassembly block. In the second communication node, the process Rx-10 may be performed in the information bit reassembly block included in the amplitude and phase offset-based reception unit 320. The information bit reassembly block may be referred to as an information bit reassembler.

### <Additional Modulation Method Based on Amplitude and Phase Offset>

An additional modulation method based on amplitude and phase offset will be described. In the additional modulation method based on amplitude and phase offset, a frequency domain spreading process and a frequency domain despreading process may be added.

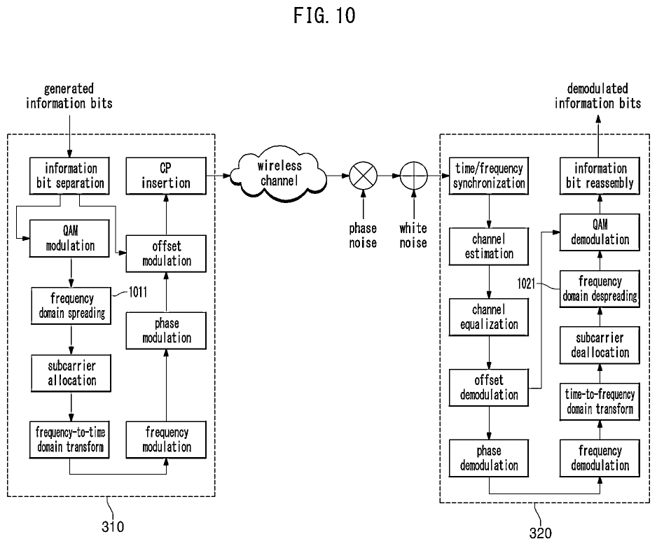

FIG. 10 is a block diagram illustrating an additional modulation method based on amplitude and phase offset according to exemplary embodiments of the present disclosure.

Referring to FIG. 10, a communication system may include a first communication node and a second communication node. The first communication node may include a transmission unit (hereinafter, ‘amplitude and phase offset-based additional transmission unit’) 1010 to which the amplitude and phase offset-based additional modulation method is applied. In the amplitude and phase offset-based additional transmission unit 1010, a frequency domain spreading process 1011 may be additionally performed between the QAM modulation process and the subcarrier allocation process. The second communication node may include a reception unit (hereinafter, ‘amplitude and phase offset-based additional reception unit’) 1020 of a reception signal to which the amplitude and phase offset-based modulation method is applied. In the amplitude and phase offset-based additional reception unit 1020, a frequency domain despreading process 1021 may be additionally performed between the QAM demodulation process and the subcarrier deallocation process. In the following description with reference to FIG. 10, description redundant with those described with reference to FIGS. 3 to 9 may be omitted.

When the first communication node applies the amplitude and phase offset-based additional modulation method, as illustrated in FIG. 10, the first communication node may perform the frequency domain spreading process 1011. The first communication node may perform the frequency domain spreading process 1011 on the signal obtained by performing the QAM modulation process. The subcarrier allocation process may be performed on a signal obtained by performing the frequency domain spreading process 1011.

When the second communication node applies the amplitude and phase offset-based additional modulation method, as illustrated in FIG. 10, the second communication node may perform the frequency domain despreading process 1021. The second communication node may perform the frequency domain despreading process 1011 on the signal obtained by performing the subcarrier deallocation process. The QAM demodulation process may be performed on a signal obtained by performing the frequency domain despreading process 1021.

As illustrated in FIG. 10, the amplitude and phase offset-based additional transmission unit 1020 may include a frequency domain spreading block 1011. In the first communication node, the frequency domain spreading process may be performed in the frequency domain spreading block 1011 included in the amplitude and phase offset-based additional transmission unit 1010. The frequency domain spreading block 1011 may be referred to as a frequency domain spreader.

As illustrated in FIG. 10, the amplitude and phase offset-based additional reception unit 1020 may include a frequency domain despreading block 1021. In the second communication node, the frequency domain despreading process may be performed in the frequency domain despreading block 1021 included in the amplitude and phase offset-based additional reception unit 1020. The frequency domain despreading block 1021 may be referred to as a frequency domain despreader.

### [Process Tx-2-1] Frequency Domain Spreading

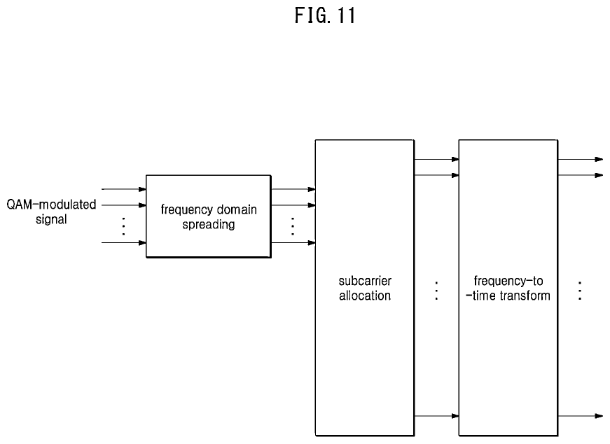

In the process Tx-2-1, the first communication node may perform frequency domain spreading on the signal obtained in the process Tx-2. As illustrated in FIG. 11, the process Tx-2-1 may be performed before the process Tx-3 for subcarrier allocation.

FIG. 11 is a block diagram illustrating a frequency domain spreading process included in the amplitude and phase offset-based additional modulation method according to exemplary embodiments of the present disclosure.

Referring to FIG. 11, in the amplitude and phase offset-based additional modulation method, the first communication node may include a frequency domain spreading block. After the process Tx-2 is applied, the first communication node may apply frequency domain spreading on the QAM-modulated signal obtained in the process Tx-2. The first communication node may perform subcarrier allocation on a signal obtained in the process Tx-2-1. The frequency-to-time domain transform may be performed on the frequency-domain signal obtained in the process Tx-3.

### [Process Rx-8-1] Frequency Domain Despreading

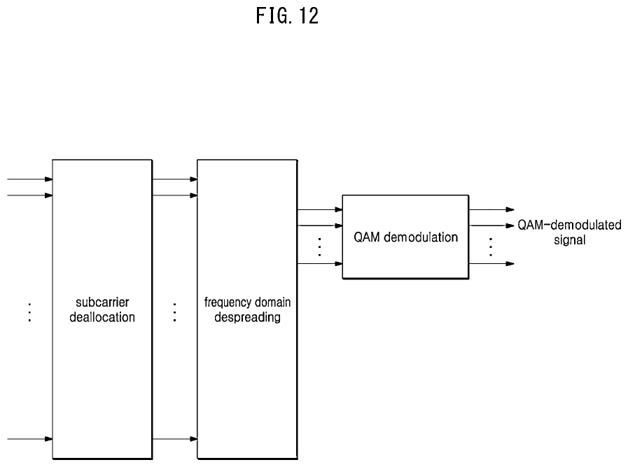

In the process Rx-8-1, the second communication node may perform despreading in the frequency domain for the complex signal sequence composed of Nₛ complex symbols obtained in the process Tx-7. When the first communication node applies frequency domain spreading as illustrated in FIG. 11, the second communication node may apply frequency domain despreading as illustrated in FIG. 12.

FIG. 12 is a block diagram illustrating a frequency domain despreading process included in the amplitude and phase offset-based additional modulation method according to exemplary embodiments of the present disclosure.

Referring to FIG. 12, in the amplitude and phase offset-based additional modulation method, the second communication node may additionally perform a frequency domain despreading process. After the subcarrier deallocation process is performed, the frequency domain despreading process may be performed in the second communication node. The second communication node may perform a frequency domain spreading process on a signal obtained by performing the subcarrier deallocation process. The QAM demodulation process may be performed on a signal obtained by performing the frequency domain spreading process. The subcarrier deallocation process may refer to the above-described process Rx-8, and the QAM demodulation process may refer to the above-described process Rx-9. The frequency domain despreading process may refer a new process Rx-8-1 included in the amplitude and phase offset-based additional modulation method as described above.

### <Amplitude and Phase Offset-Based Modulated Signal Transmission Procedure>

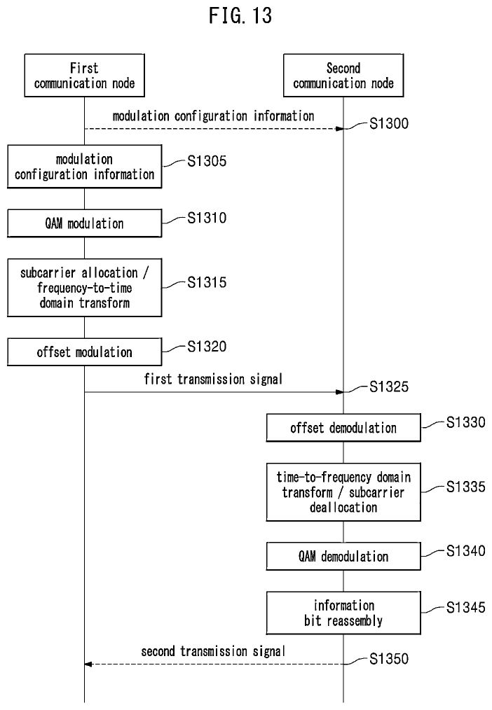

FIG. 13 is a sequence chart illustrating a transmission and reception procedure of an amplitude and phase offset-based modulated signal according to exemplary embodiments of the present disclosure.

Referring to FIG. 13, a communication system may include a first communication node and a second communication node. The first communication node may obtain a first transmission signal for information bits generated based on modulation configuration information, and transmit the first transmission signal to the second communication node. The second communication node may receive the first transmission signal from the first communication node, and the second communication node may restore the information bits generated by the first communication node from the first transmission signal according to the modulation configuration information. The second communication node may transmit a second transmission signal to the first communication node as needed. As described above, the first communication node may be either a base station or a terminal, and the second communication node may be either a terminal or a base station. If the first communication node is a base station, the second communication node may be a terminal, and the first transmission signal may correspond to downlink (DL) transmission, and the second transmission signal may correspond to uplink (UL) transmission. If the first communication node is a terminal, the second communication node may be a base station, and the first transmission signal may correspond to UL transmission, and the second transmission signal may correspond to DL transmission. If the first communication node is a terminal, the second communication node may be another terminal, and the first transmission signal and the second transmission signal may correspond to sidelink (SL) transmission. Hereinafter, in description with reference to FIG. 13, description redundant with those described with reference to FIGS. 3 to 12 may be omitted.

### [Procedure 1] Amplitude and Phase Offset-Modulated Signal Transmission Procedure

A procedure for transmitting an amplitude and phase offset-modulated signal (hereinafter, ‘procedure 1’) in the second communication node will be described. The procedure 1 may include steps S1300 to S1325 as follows.

In step S1300, the first communication node may transmit modulation configuration information to the second communication node. The second communication node may receive the modulation configuration information from the first communication node. The modulation configuration information may be transmitted through at least one of physical layer signaling, medium access control (MAC) layer signaling, radio resource control (RRC) signaling, or system information (SI) signaling.

The modulation configuration information in the second communication node may be preconfigured information or information received from the first communication node. If the modulation configuration information is preconfigured information, step S1300 may not be performed. If the modulation configuration information is information received from the first communication node, step S1300 may be performed.

The modulation configuration information may include at least one of offset modulation information, subcarrier allocation information, or QAM modulation information.

In step S1305, the first communication node may generate information bits to be transmitted to the second communication node. The generated information bits may be separated into a first bit sequence composed of a plurality of bits used for QAM modulation to be performed in step S1310 and a second bit sequence composed of a plurality of bits used for offset modulation to be performed in step S1320. The information bits may be generated by performing channel coding. The generated information bits may be expressed as an information bit sequence./

The first communication node may perform the above-described process Tx-1 to obtain the information bit sequence bᵢ and separate it into the bit sequences bᵢ_{₁} composed of N_{b}⁽¹⁾ and the bit sequences bᵢ_{₂} composed of N_{b}⁽²⁾ bits. The bit sequences bᵢ_{₁} may be used for QAM modulation, and the bit sequences bᵢ_{₂} may be used for offset modulation.

In an exemplary embodiment, the first communication node may be assumed to be a base station, and the second communication node may be assumed to be a terminal. The first communication node may generate DL traffic data and/or DL control data to be transmitted to the second communication node. The information bits may be generated by performing channel coding on the DL traffic data and/or DL control data.

In another exemplary embodiment, the first communication node may be assumed to be a terminal, and the second communication node may be assumed to be a base station. The first communication node may generate UL traffic data and/or UL control data to be transmitted to the second communication node. The information bits may be generated by performing channel coding on the UL traffic data and/or UL control data.

In another exemplary embodiment, the first communication node may be assumed to be a first terminal, and the second communication node may be assumed to be a second terminal. The first communication node may generate SL traffic data and/or SL control data to be transmitted to the second communication node. The information bits may be generated by performing channel coding on the SL traffic data and/or SL control data.

In step S1310, the first communication node may perform QAM modulation on the first bit sequence bᵢ_{₁} according to the QAM modulation information to obtain the QAM-modulated signal. When the first communication node performs QAM modulation on the first bit sequence bᵢ_{₁}, the above-described process Tx-2 may be performed in the first communication node.

Then, according to the subcarrier allocation information, the first communication node may perform step S1315 to perform subcarrier allocation on the QAM-modulated signal to obtain a frequency-domain signal. The first communication node may obtain a time-domain signal by transforming the obtained frequency-domain signal into the time domain. Step S1315 may include a step of performing subcarrier allocation (step S1316) and a step of performing frequency-to-time domain transform (step S1317). The QAM-modulated signal may be obtained by performing step S1310.

In step S1316, according to the subcarrier allocation information, the first communication node may perform subcarrier allocation for the QAM-modulated signal to obtain the frequency-domain signal. When the first communication node performs the above-described process Tx-3, the first communication node may obtain the frequency-domain signal for the QAM-modulated signal.

In step S1317, according to the subcarrier allocation information, the first communication node may perform frequency-to-time domain transform (i.e. inverse transform) on the frequency-domain signal to obtain a time-domain signal. The frequency-domain signal may be obtained by performing step S1316. When the first communication node performs the above-described process Tx-4, the first communication node may obtain the time domain-signal for the frequency-domain signal. The frequency-domain signal may be transformed into the time-domain signal by applying (or performing) one of IDFT, IDCT, or IDST.

In an exemplary embodiment, it may be assumed that the subcarrier allocation information includes information indicating application (or performance) of the first subcarrier allocation scheme. In order to obtain the frequency-domain signal for the QAM-modulated signal, the first communication node may apply (or perform) the first subcarrier allocation scheme of the above-described process Tx-3 for the QAM-modulated signal.

In order to obtain the time-domain signal for the frequency-domain signal, the first communication node may apply (or perform) the first frequency-to-time domain transform scheme of the above-described process Tx-4 for the frequency-domain signal. The frequency-domain signal may be transformed into the time-domain signal by applying (or performing) IDFT.

In another exemplary embodiment, it may be assumed that the subcarrier allocation information includes information indicating application of the second subcarrier allocation scheme. In order to obtain the frequency-domain signal for the QAM modulated signal, the first communication node may apply (or perform) the second subcarrier allocation scheme of the above-described process Tx-3 for the QAM-modulated signal.

In order to obtain the time-domain signal for the frequency-domain signal, the first communication node may apply (or perform) the second frequency-to-time domain transform scheme of the above-described process Tx-4 for the frequency-domain signal. The frequency-domain signal may be transformed into the time-domain signal by applying (or performing) one of IDCT or IDST. When the first communication node applies (or performs) the second frequency-to-time domain transform scheme, as described above, the first communication node may perform transform of the frequency-domain signal into the time-domain signal by considering position(s) of the frequency-domain signal in the frequency domain.

In the above-described exemplary embodiment and other exemplary embodiments, the subcarrier allocation information may be information indicating only one application of the first subcarrier allocation scheme or the second subcarrier allocation scheme.

Then, the first communication node may obtain an offset-modulated signal for the time-domain signal by performing step S1320. Step S1320 may include a step of performing frequency modulation (step S1321), a step of performing phase modulation (step S1322), and a step of performing offset modulation (step S1323). When the first communication node performs steps S1321 to S1323, the first communication node may obtain the offset-modulated signal for the time-domain signal. The second bit sequence may be separated from the information bit sequence generated by performing step S1305. The time-domain signal may be obtained by performing step S1315.

In step S1321, the first communication node may obtain an instantaneous phase signal by performing frequency modulation on the time-domain signal. When the first communication node performs the above-described process Tx-5, the first communication node may obtain the instantaneous phase signal for the time-domain signal.

In step S1322, the first communication node may perform phase modulation on the instantaneous phase signal to obtain a phase-modulated signal. When the first communication node performs the above-described process Tx-6, the first communication node may obtain the phase-modulated signal for the instantaneous phase signal. The instantaneous phase signal may be obtained by performing step S1321.

In step S1323, according to at least one of the offset modulation information or the second bit sequence, the first communication node may perform offset modulation on the phase-modulated signal to obtain an offset-modulated signal. When the first communication node performs the above-described process Tx-7, the first communication node may obtain (or generate) the offset-modulated signal for the phase-modulated signal. The phase-modulated signal may be obtained by performing step S1322. The second bit sequence may be separated from the information bit sequence generated by performing step S1305.

In an exemplary embodiment, it may be assumed that the offset modulation information includes at least one of information indicating amplitude-based offset modulation or amplitude offset modulation step information. The amplitude offset modulation step information may be assumed as information indicating two modulation steps.

In order to obtain the offset-modulated signal for the phase-modulated signal, the first communication node may apply (or perform) the first offset modulation scheme of the above-described process Tx-7. The offset-modulated signal may be an amplitude-based offset-modulated signal. An amplitude of the amplitude-based offset-modulated signal may be determined (or set) according to bit(s) of the second bit sequence as shown in Equation 7. When a bit of the second bit sequence is ‘0’, the amplitude of the offset-modulated signal may be determined (or set) to a preset first amplitude (e.g. A₀). When the bit of the second bit sequence is ‘1’, the amplitude of the offset-modulated signal may be determined (or set) to a preset second amplitude (e.g. A₁).

In another exemplary embodiment, it may be assumed that the offset modulation information includes at least one of information indicating phase-based offset modulation or phase offset modulation step information. The phase offset modulation step information may be assumed as information indicating two modulation steps.

In order to obtain the offset-modulated signal for the phase-modulated signal, the first communication node may apply (or perform) the second offset modulation scheme of the above-described process Tx-7. The offset-modulated signal may be a phase-based offset-modulated signal. A phase offset of the phase-based offset-modulated signal may be determined according to bit(s) of the second bit sequence as shown in Equation 8. When a bit of the second bit sequence is ‘0’, the phase offset of the offset-modulated signal may be determined (or set) to a preset first phase offset (e.g. +π/2). When the bit of the second bit sequence is ‘1’, the phase offset of the offset-modulated signal may be determined (or set) to a preset second phase offset (e.g. −π/2).

Then, the first communication node may perform step S1325 to transmit the first transmission signal to the second communication node. Step S1325 may include a step of checking whether to apply (or perform) CP insertion (step S1325), a step of performing CP insertion (S1327), and a step of transmitting the first transmission signal to the second communication node (S1327).

In step S1325, the first communication node may check whether to apply (perform) CP insertion (step S1325). If it is determined that the first communication node applies (or performs) CP insertion, the first communication node may perform CP insertion on the offset-modulated signal to obtain (or generate) the first transmission signal with a CP inserted (S1326). The first communication node may transmit the first transmission signal with a CP inserted to the second communication node. If it is determined that the first communication node does not apply (or perform) CP insertion, the first communication node may obtain (or generate) the first transmission signal without a CP and transmit it to the second communication node. The second communication node may receive the first transmission signal without a CP from the first communication node, which is the offset-modulated signal as is.

In step S1326, the first communication node may perform CP insertion on the offset-modulated signal to obtain (or generate) the first transmission signal with a CP inserted. The first communication node may transmit the first transmission signal with a CP inserted to the second communication node. The second communication node may receive the first transmission signal with a CP inserted from the first communication node.

### [Procedure 2] Amplitude and Phase Offset-Modulated Signal Reception Procedure

A procedure for receiving an amplitude and phase offset-based modulated signal in the second communication node (hereinafter, procedure 2) will be described. The procedure 2 may include steps S1325 to S1350 as follows.

In step S1325, the second communication node may receive the first transmission signal from the first communication node. The second communication node may obtain a compensated first reception signal by performing channel estimation between the first communication node and the second communication node for the first transmission signal. As described above in the process Rx-3, if it is determines that the second communication node performs CP removal, the second communication node may further perform CP removal on the compensated first reception signal. As described in the process Rx-3, the compensated first reception signal may refer to the reception signal \hat{r}[n] in which signal distortion due to the wireless channel between the first communication node and the second communication node is compensated.

In step S1330, according to the offset modulation information, the second communication node may perform offset demodulation on the first reception signal to obtain at least one of the offset-demodulated signal or the first demodulated bit sequence. When the second communication node performs offset demodulation on the first reception signal, the above-described process Rx-4 may be performed in the second communication node. The second communication node may perform step S1325 to obtain the first reception signal.

In an exemplary embodiment, the offset modulation information may include at least one of information indicating amplitude-based offset modulation or amplitude offset modulation step information. The amplitude offset modulation step information may include information indicating two or more amplitude modulation steps or information on at least one amplitude threshold related to the two or more amplitude modulation steps.

The second communication node may obtain the first demodulated bit sequence by using at least one of an amplitude of the first reception signal or the at least one amplitude threshold. The at least one amplitude threshold may refer to at least one amplitude threshold related to the two or more amplitude modulation steps indicated by the amplitude offset modulation step information.

The second transmitting node may obtain the offset-demodulated signal using at least one of the first reception signal or the first demodulated bit sequence. The offset-modulated signal may be a signal normalized so that the amplitude of the first reception signal becomes 1, a signal in which the amplitude offset of the first transmission signal is canceled out, or the first reception signal as is.

In order to obtain at least one of the offset-demodulated signal or the first demodulated bit sequence for the first reception signal, the second communication node may apply (or perform) the first offset demodulation scheme of the above-described process Rx-4. Depending on a result of comparing the amplitude of the first reception signal with a first amplitude threshold, as shown in Equation 9, the second communication node may obtain (or extract) the first demodulated bit sequence.

The amplitude offset modulation step information may include information indicating two amplitude modulation steps or the first amplitude threshold related to the two amplitude modulation steps. As described above, the first threshold may be set to an amplitude of the phase-modulated signal (e.g. an amplitude A of the phase-modulated signal s̅[n]) or a middle value between a first amplitude of the offset-modulated signal (e.g. an amplitude A₀ of the offset-modulated signal) and a second amplitude (e.g. an amplitude A₁ of the offset-modulated signal).

In another exemplary embodiment, the offset modulation information may include at least one of information indicating phase-based offset modulation or phase offset modulation step information. The phase offset modulation step information may include information indicating two or more phase modulation steps or information on at least one phase threshold related to the two or more phase modulation steps.

The second communication node may obtain the first demodulated bit sequence using at least one of an phase of the first reception signal or the at least one phase threshold. The at least one phase threshold may refer to at least one phase threshold related to the two or more phase modulation steps indicated by the phase offset modulation step information.

The second communication node may obtain an offset-demodulated signal using at least one of the first reception signal or the first demodulated bit sequence. A phase change of the offset-modulated signal may be centered around a phase value 0.

In order to obtain at least one of the offset-demodulated signal or the first demodulated bit sequence for the first reception signal, the second communication node may apply (or perform) the second offset demodulation scheme of the above-described process Rx-4. According to a result of comparing a phase of the first reception signal with a first phase threshold, as shown in Equation 13, the second communication node may obtain (or extract) the first demodulated bit sequence.

Then, according to at least one of the offset modulation information or subcarrier deallocation information, the second communication node may perform step S1335 to perform time-to-frequency domain transform on the offset-demodulated signal to obtain a frequency-domain signal. The second communication node may perform subcarrier deallocation on the obtained frequency-domain signal to obtain a complex signal sequence composed of a plurality of complex symbols. Step S1335 may include a step of performing phase demodulation (S1336), a step of performing frequency demodulation (S1337), a step of performing time-to-frequency domain transform (S1338), and a step of performing subcarrier deallocation (S1339).

In step S1336, according to the offset modulation information, the second communication node may perform phase demodulation on the offset-demodulated signal to obtain an instantaneous phase signal. The above-described process Rx-5 may be performed in the second communication node. The offset-demodulated signal may be obtained in step S1330.

In an exemplary embodiment, it may be assumed that the offset modulation information includes information indicating application (or performance) of the first offset demodulation scheme. In order to obtain the instantaneous phase signal for the offset-demodulated signal, the second communication node may apply (or perform) the first phase demodulation scheme of the process Rx-5 described above for the offset-demodulated signal.

The offset-demodulated signal may be a signal obtained by applying (or performing) the first offset demodulation scheme. The instantaneous phase signal may be expressed as an inverse tangent function of a ratio of an imaginary part and a real part of the offset-demodulated signal as shown in Equation 15.

In another exemplary embodiment, it may be assumed that the offset modulation information includes information indicating application (or performance) the second offset demodulation scheme. In order to obtain an instantaneous phase signal for the offset-demodulated signal, the second communication node may apply (or perform) the second phase demodulation scheme of the process Rx-5 described above to the offset-demodulated signal.

The offset-demodulated signal may be a signal obtained by applying (or performing) the second offset demodulation scheme. The instantaneous phase signal may be expressed as an inverse tangent function of a ratio of an imaginary part and a real part of the offset-demodulated signal as shown in Equation 16.

In step S1337, according to the subcarrier deallocation information, the second communication node may perform frequency demodulation on the instantaneous phase signal to obtain an instantaneous frequency signal. The above-described process Rx-6 may be performed in the second communication node. The instantaneous phase signal may be obtained in step S1336.

In an exemplary embodiment, it may be assumed that the subcarrier deallocation information includes information indicating application (or performance) of the first frequency demodulation scheme in the second communication node. To obtain an instantaneous frequency signal for the instantaneous phase signal, the second communication node may apply (or perform) the first frequency demodulation scheme of the process Rx-6 described above for the instantaneous phase signal.

The instantaneous frequency signal may be a signal obtained by applying (or performing) the first frequency demodulation scheme. The instantaneous frequency signal may be expressed by a backward difference operation on the instantaneous phase signal as shown in Equation 17. As described in the process Rx-5, when the first communication node applies (or performs) the first frequency modulation scheme, the second communication node may apply the first frequency demodulation scheme.

In another exemplary embodiment, it may be assumed that the subcarrier deallocation information includes information indicating application (or performance) of the second frequency demodulation scheme. In order to obtain the instantaneous frequency signal for the instantaneous phase signal, the second communication node may apply (or perform) the second frequency demodulation scheme of the process Rx-6 described above for the instantaneous phase signal.

The instantaneous frequency signal may be a signal obtained without applying (or performing) the first frequency demodulation scheme. The instantaneous frequency signal may be expressed by a backward difference operation on the instantaneous phase signal as shown in Equation 18. As described in the process Rx-5, when the first communication node applies (or performs) the second frequency modulation scheme, the second communication node may apply the second frequency demodulation scheme.

In step S1338, according to the subcarrier allocation information, the second communication node may perform time-to-frequency domain transform on the instantaneous frequency signal to obtain a frequency-domain signal. The above-described process Rx-7 may be performed in the second communication node. The instantaneous frequency signal may be obtained in step S1337.

In an exemplary embodiment, it may be assumed that the subcarrier allocation information includes information indicating application (or performance) of the first time-to-frequency domain transform scheme in the second communication node. In order to obtain the frequency-domain signal for the instantaneous frequency signal, the second communication node may apply (or perform) the first time-to-frequency domain transform scheme of the process Rx-7 described above on the instantaneous frequency signal.

The frequency-domain signal may be a signal obtained by applying (or performing) the first time-to-frequency domain transform scheme. The frequency-domain signal may be expressed as a DFT operation of the instantaneous frequency as shown in Equation 19. As described in the process Rx-7, when the first communication node applies (or performs) the first frequency-to-time domain transform scheme, the second communication node may apply (or perform) the first time-to-frequency domain transform scheme. When the first subcarrier allocation scheme is applied (or performed), the first communication node may apply (or perform) the first frequency-to-time domain transform scheme.

In another exemplary embodiment, it may be assumed that the subcarrier allocation information includes information indicating application (or performance) of the second time-to-frequency domain transform scheme in the second communication node. In order to obtain the frequency-domain signal for the instantaneous frequency signal, the second communication node may apply (or perform) the second time-to-frequency domain transform scheme of the process Rx-7 described above for the instantaneous frequency signal.

The frequency-domain signal may be a signal obtained by applying (or performing) the second time-to-frequency domain transform scheme. The frequency-domain signal may be expressed by the DCT operation or the DST operation on the instantaneous frequency as shown in Equation 20 or Equation 21. As described in the process Rx-7, when the first communication node applies (or performs) the second frequency-to-time domain transform scheme, the second communication node may apply (or perform) the second time-to-frequency domain transform scheme. When the second subcarrier allocation scheme is applied (or performed), the first communication node may apply (or perform) the second frequency-to-time domain transform scheme.

In step S1339, according to the subcarrier allocation information, the second communication node may perform subcarrier deallocation on the frequency-domain signal to obtain the complex sequence for the frequency-domain signal. The above-described process Rx-8 may be performed in the second communication node. The frequency-domain signal may be obtained in step S1338.

In an exemplary embodiment, it may be assumed that the subcarrier allocation information includes information indicating application (or performance) of the first subcarrier deallocation scheme in the second communication node. In order to obtain the complex sequence for the frequency-domain signal, the second communication node may apply (or perform) the first subcarrier deallocation scheme of the process Rx-8 described above for the instantaneous frequency signal.

The complex sequence may be a signal obtained by applying (or performing) the first subcarrier deallocation scheme. As described above, the complex sequence may be obtained from at least one of the first region of the frequency-domain signal and the second region of the frequency-domain signal based on the center of the entire subcarrier region. The frequency-domain signal included in the first region and the second region may correspond to the QAM-modulated signal to which subcarriers are allocated in the first communication node. The QAM-modulated signal to which subcarriers are allocated in the first communication node may be conjugate symmetric based on the center of the entire subcarrier region as illustrated in FIG. 4.

In another exemplary embodiment, it may be assumed that the subcarrier allocation information includes information indicating application (or performance) of the second subcarrier deallocation scheme in the second communication node. In order to obtain the complex sequence for the frequency-domain signal, the second communication node may apply (or perform) the second subcarrier deallocation scheme of the process Rx-8 described above for the instantaneous frequency signal.

The complex sequence may be a signal obtained by applying (or performing) the second subcarrier deallocation scheme. The complex sequence may be obtained by using the first region of the frequency-domain signal and the second region of the frequency-domain signal as illustrated in FIG. 9. The first region may correspond to a real part of the frequency-domain signal, and the second region may correspond to an imaginary part of the frequency-domain signal. The first region and the second region may be continuous in the frequency domain, and the second region may be located after the first region.

In step S1340, according to at least one of the QAM modulation information or the first demodulated bit sequence, the second communication node may perform QAM demodulation on the complex sequence to obtain a second demodulated bit sequence composed of a plurality of bits. The above-described process Rx-9 may be performed in the second communication node. The first demodulated bit sequence may be obtained in step S1330.

In step S1345, the second communication node may perform reassembly on the first demodulated bit sequence and the second demodulated bit sequence to obtain a demodulated bit sequence. The above-described process Rx-10 may be performed in the second communication node. The first demodulated bit sequence may be obtained in step S1330, and the second demodulated bit sequence may be obtained in step S1340.

In step S1350, the second communication node may transmit the second transmission signal to the first communication node as needed. The first communication node may receive the second transmission signal from the second communication node.

In an exemplary embodiment, the first communication node may be assumed to be a base station, and the second communication node may be assumed to be a terminal. The first transmission signal may include a control data channel including DCI information for UL scheduling. The second communication node may transmit a second transmission signal including a UL data channel to the first communication node according to the first transmission signal.

In another exemplary embodiment, the first communication node may be assumed to be a terminal, and the second communication node may be assumed to be a base station. The first communication node may transmit the first transmission signal including a scheduling request to the second communication node. The second communication node may receive the first transmission signal including the scheduling request from the first communication node. The second communication node may transmit a second transmission signal including a UL grant to the first communication node in response to the scheduling request of the first communication node.

In another exemplary embodiment, the first communication node may be assumed to be a first terminal, and the second communication node may be assumed to be a second terminal. As communication between the first communication node and the second communication node, SL communication may be used.

The first communication node may transmit the first transmission signal to the second communication node, and the second communication node may receive the first transmission signal from the first communication node. The first transmission signal between the first communication node and the second communication node may be transmitted based on SL groupcast. The first transmission signal may include an SL data channel including data transmitted from the first communication node to the second communication node.

The second communication node may receive the SL data channel including data transmitted from the first communication node to the second communication node. The second communication node may receive the SL data channel included in the first transmission signal and perform decoding of the SL data channel. If decoding of the SL data channel fails, the second communication node may transmit a second transmission signal indicating the failure of decoding the SL data channel included in the first transmission signal to the first communication node, and the first communication node may receive the second transmission signal indicating the failure of decoding the SL data channel included in the first transmission signal from the second communication node.

Although steps S1300 to S1350 have been described individually, this is not intended to limit the order in which the steps are performed, and if necessary, the respective steps may be performed simultaneously or in a different order, or at least some of the steps may be combined.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a second communication node, comprising:
obtaining a compensated first reception signal by performing channel estimation between a first communication node and a second communication node for a first transmission signal received from the first communication node;
obtaining an offset-demodulated signal and a first demodulated bit sequence by performing offset-demodulation on the first reception signal according to offset-modulation information;
obtaining a frequency-domain signal by performing time-to-frequency domain transform on the offset-demodulated signal according to the offset-modulation information or subcarrier allocation information;
obtaining a complex signal sequence by performing subcarrier deallocation on the frequency-domain signal according to the subcarrier allocation information;
obtaining a second demodulated bit sequence by performing quadrature amplitude modulation (QAM) demodulation on the complex signal sequence according to QAM modulation information and the first demodulated bit sequence; and
obtaining a final demodulated bit sequence by performing reassembly on the first demodulated bit sequence and the second demodulated bit sequence.

2. The method according to claim 1, wherein the offset-demodulated signal is obtained after obtaining the first demodulated bit sequence, and the frequency-domain signal is obtained by applying one of a discrete Fourier transform (DFT), a discrete cosine transform (DCT), or a discrete sine transform (DST).

3. The method according to claim 1, further comprising: receiving modulation configuration information from the first communication node, wherein the modulation configuration information is received through at least one of physical layer signaling, medium access control (MAC) layer signaling, radio resource control (RRC) signaling, or system information (SI) signaling.

4. The method according to claim 3, wherein the modulation configuration information includes at least one of the offset modulation information, the subcarrier allocation information, or the QAM modulation information.

5. The method according to claim 1, wherein the offset modulation information includes at least one of information indicating application of amplitude-based offset modulation or amplitude offset modulation step information, the amplitude offset modulation step information includes information indicating two or more amplitude modulation steps or information on at least one amplitude threshold related to the two or more amplitude modulation steps, the first demodulated bit sequence is obtained by using at least one of an amplitude of the first reception signal or the at least one amplitude threshold, and the offset-demodulated signal is obtained by using at least one of the first reception signal or the first demodulated bit sequence.

6. The method according to claim 5, wherein the offset-demodulated signal is one of a signal normalized so that the amplitude of the first reception signal becomes 1, a signal in which an amplitude offset of the first reception signal is canceled out, or the first reception signal.

7. The method according to claim 1, wherein the offset modulation information includes at least one of information indicating application of phase-based offset modulation or phase offset modulation step information, the phase offset modulation step information includes information indicating two or more phase modulation steps or information on at least one phase threshold related to the two or more phase modulation steps, the first demodulated bit sequence is obtained by using at least one of a phase of the first reception signal or the at least one phase threshold, and the offset-demodulated signal is obtained by using at least one of the first reception signal or the first demodulated bit sequence.

8. The method according to claim 1, wherein the subcarrier allocation information includes information indicating application of a first subcarrier allocation scheme, the complex signal sequence is obtained by using at least one of a first region or a second region including the frequency-domain signal, and a QAM-modulated signal to which subcarriers are allocated by the first communication node, which corresponds to the frequency-domain signal included in the first region and the second region, is conjugate symmetric in frequency domain.

9. The method according to claim 1, wherein the subcarrier allocation information includes information indicating application of a second subcarrier allocation scheme, the complex signal sequence is obtained by using the frequency-domain signal, the frequency-domain signal is a complex signal including a first region corresponding to real components and a second region corresponding to imaginary components, the first region and the second region are continuous in frequency domain, and the second region is located after the first region.

10. The method according to claim 1, wherein the obtaining of the complex signal sequence comprises:
obtaining an instantaneous phase signal by performing phase demodulation on the offset-demodulated signal according to the offset modulation information;
obtaining an instantaneous frequency signal by performing frequency demodulation on the instantaneous phase signal according to the subcarrier allocation information;
obtaining the frequency-domain signal by performing time-to-frequency domain transform on the instantaneous frequency signal according to the subcarrier allocation information; and
obtaining the complex signal sequence from the frequency-domain signal by performing subcarrier deallocation on the frequency-domain signal according to the subcarrier allocation information.

11. A method of a first communication node, comprising:
separating information bits to be transmitted to a second communication node into a first bit sequence and a second bit sequence;
obtaining a quadrature amplitude modulation (QAM)-modulated signal by performing QAM modulation on the first bit sequence according to QAM modulation information;
obtaining a frequency-domain signal by performing subcarrier allocation on the QAM-modulated signal according to subcarrier allocation information;
obtaining a time-domain signal by performing frequency-to-time domain transform on the frequency-domain signal;
obtaining an offset-modulated signal by performing offset-modulation on the time-domain signal according to offset-modulation information and the second bit sequence; and
transmitting a first transmission signal generated using the offset-modulated signal to the second communication node,
wherein the frequency-domain signal is transformed into the time-domain signal by applying one of an inverse discrete Fourier transform (IDFT), an inverse discrete cosine transform (IDCT), or an inverse discrete sine transform (IDST).

12. The method according to claim 11, further comprising: transmitting modulation configuration information to the second communication node, wherein the modulation configuration information is transmitted through at least one of physical layer signaling, medium access control (MAC) layer signaling, radio resource control (RRC) signaling, or system information (SI) signaling.

13. The method according to claim 12, wherein the modulation configuration information includes at least one of the offset modulation information, the subcarrier allocation information, or the QAM modulation information.

14. The method according to claim 11, wherein the subcarrier allocation information includes information indicating application of a first subcarrier allocation scheme, the frequency-domain signal includes a first region and a second region to which the QAM-modulated signal is allocated within an entire subcarrier region, the first region and the second region are conjugate symmetrical with respect to a center of the entire subcarrier region, a central region between the first region and the second region is a portion to which the QAM-modulated signal is not allocated, and the frequency-domain signal is transformed into the time-domain signal through IDFT.

15. The method according to claim 11, wherein the subcarrier allocation information includes information indicating application of a second subcarrier allocation scheme, the frequency-domain signal includes a first region and a second region which are continuous, the second region is located after the first region, the first region corresponds to real components of the QAM-modulated signal, the second region corresponds to values obtained by converting imaginary components of the QAM-modulated signal to ream numbers, and the frequency-domain signal is transformed into the time-domain signal through one of IDCT or IDST.

16. The method according to claim 14, wherein when the frequency-domain signal is determined to be located in a subcarrier region higher than a predefined subcarrier in the entire subcarrier region, the frequency-domain signal is transformed into the time-domain signal by applying IDST, and when the frequency-domain signal is determined to be located in a subcarrier region lower than the predefined subcarrier in the entire subcarrier region, the frequency-domain signal is transformed into the time-domain signal by applying one of IDFT or IDCT.

17. The method according to claim 11, wherein the offset modulation information includes at least one of information indicating application of amplitude-based offset modulation or amplitude offset modulation step information, and the offset-modulated signal is an amplitude-based offset-modulated signal, an amplitude of the offset-modulated signal is determined according to the second bit sequence, and the amplitude offset modulation step information is information indicating two or more modulation steps.

18. The method according to claim 11, wherein the obtaining of the offset-modulated signal comprises:
obtaining an instantaneous phase signal by performing frequency demodulation on the time-domain signal;
obtaining a phase-modulated signal by performing phase modulation on the instantaneous phase signal; and
obtaining the offset-modulated signal by performing the offset modulation on the phase-modulated signal according to at least one of the offset modulation information or the second bit sequence.

19. A second communication node comprising at least one processor, wherein the at least one processor causes the second communication node to perform:
obtaining a compensated first reception signal by performing channel estimation between a first communication node and a second communication node for a first transmission signal received from the first communication node;
obtaining an offset-demodulated signal and a first demodulated bit sequence by performing offset-demodulation on the first reception signal according to offset-modulation information;
obtaining a frequency-domain signal by performing time-to-frequency domain transform on the offset-demodulated signal according to the offset-modulation information or subcarrier allocation information;
obtaining a complex signal sequence by performing subcarrier deallocation on the frequency-domain signal according to the subcarrier allocation information;
obtaining a second demodulated bit sequence by performing quadrature amplitude modulation (QAM) demodulation on the complex signal sequence according to QAM modulation information and the first demodulated bit sequence; and
obtaining a final demodulated bit sequence by performing reassembly on the first demodulated bit sequence and the second demodulated bit sequence.

20. The second communication node according to claim 19, wherein the offset-demodulated signal is obtained after obtaining the first demodulated bit sequence, and the frequency-domain signal is obtained by applying one of a discrete Fourier transform (DFT), a discrete cosine transform (DCT), or a discrete sine transform (DST).
